(19) United States
(12) Patent Application Publication
(10) Pub. No.: US 2026/0222341 A1
(43) Pub. Date: Jul. 30, 2026

(54) INBOUND TRANSPORT FOR USER EQUIPMENT HOSTED DATA SERVICES

(71) Applicant: QUALCOMM Incorporated, San Diego, CA (US)

(72) Inventors: Karl Georg HAMPEL, Jersey City, NJ (US); Tien Viet NGUYEN, Bridgewater, NJ (US); Hua WANG, Basking Ridge, NJ (US); Hong CHENG, Basking Ridge, NJ (US); Miguel GRIOT, La Jolla, CA (US); Junyi LI, Greentown, PA (US)

(21) Appl. No.: 19/041,026

(22) Filed: Jan. 30, 2025

(51) Int. Cl. H04L 45/74; H04L 61/5007

(52) U.S. Cl. CPC H04L 45/74; H04L 61/5007

(57) ABSTRACT

Methods, systems, and devices for wireless communications are described. A user equipment (UE) may perform one or more operations to support hosting services and inbound traffic at the UE. For example, the UE may transmit, via a wireless link, a first message including a request to pass inbound traffic to the UE from one or more remote locations. The UE may transmit the first message to a management entity. The first message may further include an indication of a set of transport or traffic characteristics associated with the inbound traffic. The UE may receive, in accordance with transmitting the first message, a second message that indicates whether the request to pass the inbound traffic is accepted. The UE may receive, in accordance with an acceptance of the request, the inbound traffic from the one or more remote locations.

### FIELD OF TECHNOLOGY

The following relates to wireless communications, including inbound transport for user equipment (UE) hosted data services.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, via a wireless communications link, a first non-access stratum (NAS) message including a request to pass inbound traffic to the UE, where the inbound traffic is associated with a first service hosted at the UE, receiving, in accordance with transmitting the first NAS message, a second NAS message that indicates whether the request to pass the inbound traffic is accepted, and receiving, in accordance with an acceptance of the request, the inbound traffic from one or more remote locations.

A UE for wireless communications is described. The UE may include one or more memories storing processor executable code, and one or more processors coupled with the one or more memories. The one or more processors may individually or collectively be operable to execute the code to cause the UE to transmit, via a wireless communications link, a first NAS message including a request to pass inbound traffic to the UE, where the inbound traffic is associated with a first service hosted at the UE, receive, in accordance with transmitting the first NAS message, a second NAS message that indicates whether the request to pass the inbound traffic is accepted, and receive, in accordance with an acceptance of the request, the inbound traffic from one or more remote locations.

Another UE for wireless communications is described. The UE may include means for transmitting, via a wireless communications link, a first NAS message including a request to pass inbound traffic to the UE, where the inbound traffic is associated with a first service hosted at the UE, means for receiving, in accordance with transmitting the first NAS message, a second NAS message that indicates whether the request to pass the inbound traffic is accepted, and means for receiving, in accordance with an acceptance of the request, the inbound traffic from one or more remote locations.

A non-transitory computer-readable medium storing code for wireless communications is described. The code may include instructions executable by one or more processors to transmit, via a wireless communications link, a first NAS message including a request to pass inbound traffic to the UE, where the inbound traffic is associated with a first service hosted at the UE, receive, in accordance with transmitting the first NAS message, a second NAS message that indicates whether the request to pass the inbound traffic is accepted, and receive, in accordance with an acceptance of the request, the inbound traffic from one or more remote locations.

Some examples of the method, UEs, and non-transitory computer-readable medium described herein may further include operations, features, means, or instructions for transmitting, via the wireless communications link and as part of a procedure for establishing a packet data unit (PDU) session, a message including a request for a publicly routable internet protocol (IP) address or a publicly routable IP prefix and receiving, in response to the message and as part of the procedure, an indication of the publicly routable IP prefix or the publicly routable IP address for the PDU session, where transmitting the first NAS message may be in accordance with receiving the indication.

Some examples of the method, UEs, and non-transitory computer-readable medium described herein may further include operations, features, means, or instructions for selecting, in accordance with receiving the indication, an IP address for the first service according to the publicly routable IP prefix, where the first NAS message includes an indication of the selected IP address for the first service.

Some examples of the method, UEs, and non-transitory computer-readable medium described herein may further include operations, features, means, or instructions for initializing, in accordance with the acceptance of the request to pass the inbound traffic, one or more server functions associated with the first service for the selected IP address, where receiving the inbound traffic may be in accordance with initializing the one or more server functions.

Some examples of the method, UEs, and non-transitory computer-readable medium described herein may further include operations, features, means, or instructions for transmitting, to the one or more remote locations, one or more response messages in response to the inbound traffic.

In some examples of the method, UEs, and non-transitory computer-readable medium described herein, each of the one or more remote locations corresponds to a respective IP address, a respective IP prefix, or any combination thereof.

In some examples of the method, UEs, and non-transitory computer-readable medium described herein, the first NAS message further includes an indication of a set of transport or traffic characteristics associated with the inbound traffic and receiving the inbound traffic may be based on the inbound traffic being in accordance with the set of transport or traffic characteristics.

In some examples of the method, UEs, and non-transitory computer-readable medium described herein, the set of transport or traffic characteristics includes an IP address associated with the first service, a transport layer protocol type associated with the first service, a transport layer port identifier associated with the first service, or any combination thereof.

In some examples of the method, UEs, and non-transitory computer-readable medium described herein, the set of transport or traffic characteristics includes a range of supported IP addresses associated with the one or more remote locations associated with the inbound traffic, a range of supported transport protocol port identifiers associated with the one or more remote locations, or both.

In some examples of the method, UEs, and non-transitory computer-readable medium described herein, the set of transport or traffic characteristics includes a range of restricted IP addresses that may be restricted from communicating inbound traffic.

In some examples of the method, UEs, and non-transitory computer-readable medium described herein, the set of transport or traffic characteristics includes one or more first time windows during which the inbound traffic may be permitted to be communicated, one or more second time windows during which the inbound traffic may be restricted from being communicated, or both.

In some examples of the method, UEs, and non-transitory computer-readable medium described herein, the set of transport or traffic characteristics includes a first threshold quantity of inbound traffic attempts permitted per time interval per remote location of the one or more remote locations, a second threshold quantity of inbound traffic attempts permitted per time interval in total, or both.

A method for wireless communications by a UE is described. The method may include transmitting, via a wireless communications link, a first message including a request to communicate with a port control protocol (PCP) server used to pass inbound traffic to the UE, receiving, via the wireless communications link and in accordance with receiving the first message, a second message that indicates an IP address of the PCP server, a domain name of the PCP server, or both, where the inbound traffic is associated with a first service hosted at the UE, transmitting, to the PCP server and in accordance with receiving the second message, a PCP request message that indicates a set of transport or traffic characteristics associated with the inbound traffic, and receiving the inbound traffic from one or more remote locations according to the set of transport or traffic characteristics and via the PCP server.

A UE for wireless communications is described. The UE may include one or more memories storing processor executable code, and one or more processors coupled with the one or more memories. The one or more processors may individually or collectively be operable to execute the code to cause the UE to transmit, via a wireless communications link, a first message including a request to communicate with a PCP server used to pass inbound traffic to the UE, receive, via the wireless communications link and in accordance with receiving the first message, a second message that indicates an IP address of the PCP server, a domain name of the PCP server, or both, where the inbound traffic is associated with a first service hosted at the UE, transmit, to the PCP server and in accordance with receiving the second message, a PCP request message that indicates a set of transport or traffic characteristics associated with the inbound traffic, and receive the inbound traffic from one or more remote locations according to the set of transport or traffic characteristics and via the PCP server.

Another UE for wireless communications is described. The UE may include means for transmitting, via a wireless communications link, a first message including a request to communicate with a PCP server used to pass inbound traffic to the UE, means for receiving, via the wireless communications link and in accordance with receiving the first message, a second message that indicates an IP address of the PCP server, a domain name of the PCP server, or both, where the inbound traffic is associated with a first service hosted at the UE, means for transmitting, to the PCP server and in accordance with receiving the second message, a PCP request message that indicates a set of transport or traffic characteristics associated with the inbound traffic, and means for receiving the inbound traffic from one or more remote locations according to the set of transport or traffic characteristics and via the PCP server.

A non-transitory computer-readable medium storing code for wireless communications is described. The code may include instructions executable by one or more processors to transmit, via a wireless communications link, a first message including a request to communicate with a PCP server used to pass inbound traffic to the UE, receive, via the wireless communications link and in accordance with receiving the first message, a second message that indicates an IP address of the PCP server, a domain name of the PCP server, or both, where the inbound traffic is associated with a first service hosted at the UE, transmit, to the PCP server and in accordance with receiving the second message, a PCP request message that indicates a set of transport or traffic characteristics associated with the inbound traffic, and receive the inbound traffic from one or more remote locations according to the set of transport or traffic characteristics and via the PCP server.

Some examples of the method, UEs, and non-transitory computer-readable medium described herein may further include operations, features, means, or instructions for establishing the wireless communications link with a management entity of a core network associated with the UE, where the wireless communications link includes a radio resource control connection.

Some examples of the method, UEs, and non-transitory computer-readable medium described herein may further include operations, features, means, or instructions for transmitting, via the first message, a second request for a set of publicly routable IP addresses including the IP address of the PCP server, where receiving the second message may be in accordance with transmitting the second request.

Some examples of the method, UEs, and non-transitory computer-readable medium described herein may further include operations, features, means, or instructions for receiving, via the second message, a publicly routable IP prefix for a PDU session, where the IP address of the PCP server may be in accordance with the publicly routable IP prefix.

Some examples of the method, UEs, and non-transitory computer-readable medium described herein may further include operations, features, means, or instructions for receiving, in response to the PCP request message, a PCP acknowledgment message that indicates an acceptance of the PCP request message, where receiving the inbound traffic may be in accordance with the acceptance of the PCP request message.

Some examples of the method, UEs, and non-transitory computer-readable medium described herein may further include operations, features, means, or instructions for initializing one or more server functions associated with the first service for the IP address of the PCP server, where receiving the inbound traffic may be in accordance with initializing the one or more server functions.

Some examples of the method, UEs, and non-transitory computer-readable medium described herein may further include operations, features, means, or instructions for transmitting, to the one or more remote locations, one or more response messages in response to the inbound traffic.

In some examples of the method, UEs, and non-transitory computer-readable medium described herein, the set of transport or traffic characteristics includes an IP address associated with the first service, a transport layer protocol type associated with the first service, a transport layer port identifier associated with the first service, or any combination thereof.

In some examples of the method, UEs, and non-transitory computer-readable medium described herein, the set of transport or traffic characteristics includes a range of supported IP addresses associated with the one or more remote locations, a range of supported transport protocol port identifiers associated with the one or more remote locations, or both.

In some examples of the method, UEs, and non-transitory computer-readable medium described herein, the set of transport or traffic characteristics includes a range of restricted IP addresses that may be restricted from communicating inbound traffic.

A method for wireless communications by a management entity is described. The method may include receiving, via a wireless communications link and from a UE, a first NAS message including a request to pass inbound traffic to the UE, where the inbound traffic is associated with a first service hosted at the UE, transmitting, to a second management entity, a verification message to verify whether the UE is associated with a subscription to pass the inbound traffic, and transmitting, to the UE, a second NAS message that indicates that the request to pass the inbound traffic is accepted in accordance with the UE being associated with the subscription.

A management entity for wireless communications is described. The management entity may include one or more memories storing processor executable code, and one or more processors coupled with the one or more memories. The one or more processors may individually or collectively be operable to execute the code to cause the management entity to receive, via a wireless communications link and from a UE, a first NAS message including a request to pass inbound traffic to the UE, where the inbound traffic is associated with a first service hosted at the UE, transmit, to a second management entity, a verification message to verify whether the UE is associated with a subscription to pass the inbound traffic, and transmit, to the UE, a second NAS message that indicates that the request to pass the inbound traffic is accepted in accordance with the UE being associated with the subscription.

Another management entity for wireless communications is described. The management entity may include means for receiving, via a wireless communications link and from a UE, a first NAS message including a request to pass inbound traffic to the UE, where the inbound traffic is associated with a first service hosted at the UE, means for transmitting, to a second management entity, a verification message to verify whether the UE is associated with a subscription to pass the inbound traffic, and means for transmitting, to the UE, a second NAS message that indicates that the request to pass the inbound traffic is accepted in accordance with the UE being associated with the subscription.

A non-transitory computer-readable medium storing code for wireless communications is described. The code may include instructions executable by one or more processors to receive, via a wireless communications link and from a UE, a first NAS message including a request to pass inbound traffic to the UE, where the inbound traffic is associated with a first service hosted at the UE, transmit, to a second management entity, a verification message to verify whether the UE is associated with a subscription to pass the inbound traffic, and transmit, to the UE, a second NAS message that indicates that the request to pass the inbound traffic is accepted in accordance with the UE being associated with the subscription.

Some examples of the method, management entities, and non-transitory computer-readable medium described herein may further include operations, features, means, or instructions for receiving, from the second management entity, a data management message that indicates that the UE permits passing the inbound traffic, where transmitting the second NAS message may be in accordance with the data management message.

Some examples of the method, management entities, and non-transitory computer-readable medium described herein may further include operations, features, means, or instructions for establishing a charging association for the first service in accordance with verifying that the UE may be associated with the subscription to host the first service, where transmitting the second NAS message may be responsive to establishing the charging association.

In some examples of the method, management entities, and non-transitory computer-readable medium described herein, the first NAS message further includes an indication of a set of traffic characteristics associated with passing the inbound traffic.

Some examples of the method, management entities, and non-transitory computer-readable medium described herein may further include operations, features, means, or instructions for generating, in accordance with the set of traffic characteristics, a configuration associated with passing the inbound traffic, where transmitting the second NAS message may be responsive to generating the configuration.

Some examples of the method, management entities, and non-transitory computer-readable medium described herein may further include operations, features, means, or instructions for transmitting, to a user plane function (UPF), a regulation request for the UPF to regulate the inbound traffic in accordance with the configuration, where the regulation request includes an indication of the configuration.

A method for wireless communications by a management entity is described. The method may include receiving, via a wireless communications link and from a UE, a first message including a request to communicate with a PCP server used to pass inbound traffic to the UE, transmitting, via the wireless communications link and in accordance with receiving the first message, a second message that indicates an IP address of the PCP server, a domain name of the PCP server, or both, where the inbound traffic is associated with a first service hosted at the UE, receiving, via the wireless communications link, a first NAS message that indicates a set of transport or traffic characteristics associated with the inbound traffic, and transmitting, to the UE, a second NAS message that indicates that the request to communicate with the PCP server is accepted in accordance with the UE being associated with a subscription to pass the inbound traffic.

A management entity for wireless communications is described. The management entity may include one or more memories storing processor executable code, and one or more processors coupled with the one or more memories. The one or more processors may individually or collectively be operable to execute the code to cause the management entity to receive, via a wireless communications link and from a UE, a first message including a request to communicate with a PCP server used to pass inbound traffic to the UE, transmit, via the wireless communications link and in accordance with receiving the first message, a second message that indicates an IP address of the PCP server, a domain name of the PCP server, or both, where the inbound traffic is associated with a first service hosted at the UE, receive, via the wireless communications link, a first NAS message that indicates a set of transport or traffic characteristics associated with the inbound traffic, and transmit, to the UE, a second NAS message that indicates that the request to communicate with the PCP server is accepted in accordance with the UE being associated with a subscription to pass the inbound traffic.

Another management entity for wireless communications is described. The management entity may include means for receiving, via a wireless communications link and from a UE, a first message including a request to communicate with a PCP server used to pass inbound traffic to the UE, means for transmitting, via the wireless communications link and in accordance with receiving the first message, a second message that indicates an IP address of the PCP server, a domain name of the PCP server, or both, where the inbound traffic is associated with a first service hosted at the UE, means for receiving, via the wireless communications link, a first NAS message that indicates a set of transport or traffic characteristics associated with the inbound traffic, and means for transmitting, to the UE, a second NAS message that indicates that the request to communicate with the PCP server is accepted in accordance with the UE being associated with a subscription to pass the inbound traffic.

A non-transitory computer-readable medium storing code for wireless communications is described. The code may include instructions executable by one or more processors to receive, via a wireless communications link and from a UE, a first message including a request to communicate with a PCP server used to pass inbound traffic to the UE, transmit, via the wireless communications link and in accordance with receiving the first message, a second message that indicates an IP address of the PCP server, a domain name of the PCP server, or both, where the inbound traffic is associated with a first service hosted at the UE, receive, via the wireless communications link, a first NAS message that indicates a set of transport or traffic characteristics associated with the inbound traffic, and transmit, to the UE, a second NAS message that indicates that the request to communicate with the PCP server is accepted in accordance with the UE being associated with a subscription to pass the inbound traffic.

Some examples of the method, management entities, and non-transitory computer-readable medium described herein may further include operations, features, means, or instructions for selecting a UPF that supports the PCP server and receiving, from the UPF, an IP address message including the IP address of the PCP server, where transmitting the second NAS message may be in accordance with receiving the IP address message.

Some examples of the method, management entities, and non-transitory computer-readable medium described herein may further include operations, features, means, or instructions for exchanging one or more messages with a second management entity to verify whether the UE may be associated with the subscription to pass the inbound traffic, where transmitting the second NAS message may be in accordance with the UE being associated with the subscription.

Some examples of the method, management entities, and non-transitory computer-readable medium described herein may further include operations, features, means, or instructions for establishing a charging association for the first service in accordance with verifying that the UE may be associated with the subscription to host the first service, where transmitting the second NAS message may be responsive to establishing the charging association.

Some examples of the method, management entities, and non-transitory computer-readable medium described herein may further include operations, features, means, or instructions for generating, in accordance with the set of transport or traffic characteristics, a configuration associated with passing the inbound traffic and transmitting, to a UPF, a regulation request for the UPF to regulate the inbound traffic in accordance with the configuration, where the regulation request includes an indication of the configuration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports inbound transport for user equipment (UE) hosted data services in accordance with one or more aspects of the present disclosure.

FIG. 2 shows an example of a wireless communications system that supports inbound transport for UE hosted data services in accordance with one or more aspects of the present disclosure.

FIG. 3 shows an example of a process flow that supports inbound transport for UE hosted data services in accordance with one or more aspects of the present disclosure.

FIG. 4 shows an example of a process flow that supports inbound transport for UE hosted data services in accordance with one or more aspects of the present disclosure.

FIGS. 5 and 6 show block diagrams of devices that support inbound transport for UE hosted data services in accordance with one or more aspects of the present disclosure.

FIG. 7 shows a block diagram of a communications manager that supports inbound transport for UE hosted data services in accordance with one or more aspects of the present disclosure.

FIG. 8 shows a diagram of a system including a device that supports inbound transport for UE hosted data services in accordance with one or more aspects of the present disclosure.

FIGS. 9 and 10 show block diagrams of devices that support inbound transport for UE hosted data services in accordance with one or more aspects of the present disclosure.

FIG. 11 shows a block diagram of a communications manager that supports inbound transport for UE hosted data services in accordance with one or more aspects of the present disclosure.

FIG. 12 shows a diagram of a system including a device that supports inbound transport for UE hosted data services in accordance with one or more aspects of the present disclosure.

FIGS. 13 through 16 show flowcharts illustrating methods that support inbound transport for UE hosted data services in accordance with one or more aspects of the present disclosure.

### DETAILED DESCRIPTION

In some wireless communications systems, a user equipment (UE) may host a service (e.g., host a data service, where computation associated with the service are performed at the UE and the results are provided to a remote location from the UE). As part of hosting the service, the UE may receive inbound traffic from one or more remote locations (e.g., remote internet protocol (IP) addresses) at various times, without first transmitting outbound traffic to such remote locations. In such cases, however, some inbound traffic may be blocked by one or more security features (e.g., a firewall) of a wireless network (e.g., a 5G network), which may inhibit the UE from receiving requests for the service. Additionally, if a hole is punched in the firewall (e.g., if one or more security features are disabled) for some inbound traffic (e.g., for hosting a service at the UE), the UE may become vulnerable to security attacks. Thus, techniques may be desired to enable the UE hosting a service to securely and efficiently communicate with one or more remote devices.

A UE may perform one or more operations to support hosting services and receiving inbound traffic at the UE. For example, the UE may transmit, via a wireless link and to a management entity (e.g., a session management function (SMF), a first non-access stratum (NAS) message including a request to pass inbound traffic (e.g., through a firewall) to the UE from one or more remote locations (e.g., client devices). In some examples, the first NAS message may further include an indication of a set of transport or traffic characteristics associated with the inbound traffic (e.g., traffic characteristics associated with inbound traffic that is permitted to be passed to the UE). The UE may receive, in accordance with transmitting the first NAS message and from the management entity, a second NAS message that indicates whether the request to pass the inbound traffic is accepted. The UE may receive, in accordance with an acceptance of the request, the inbound traffic from the one or more remote locations (e.g., according to the set of transport or traffic characteristics). Accordingly, the UE may host one or more services for the one or more remote locations, which may reduce latency for other UEs accessing the one or more services. Such techniques may also improve processing efficiency for applications (e.g., applications hosted at a UE with relatively high processing power) and may increase content reliability and authenticity for these applications, among other advantages.

Additionally, or alternatively, the UE may transmit, via the wireless link, a first message including a request to communicate with a port control protocol (PCP) server (e.g., as defined by IETF RFC 6887) used to pass inbound traffic to the UE from one or more remote locations. The UE may receive a second message that indicates an IP address of the PCP server, a domain name of the PCP server, or both. In response to receiving the second message, the UE may transmit, to the PCP server, a PCP request message that indicates a set of transport or traffic characteristics associated with the inbound traffic. Accordingly, the UE may receive the inbound traffic from the one or more remote locations via the PCP server (e.g., according to the set of transport or traffic characteristics).

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to inbound transport for UE hosted data services.

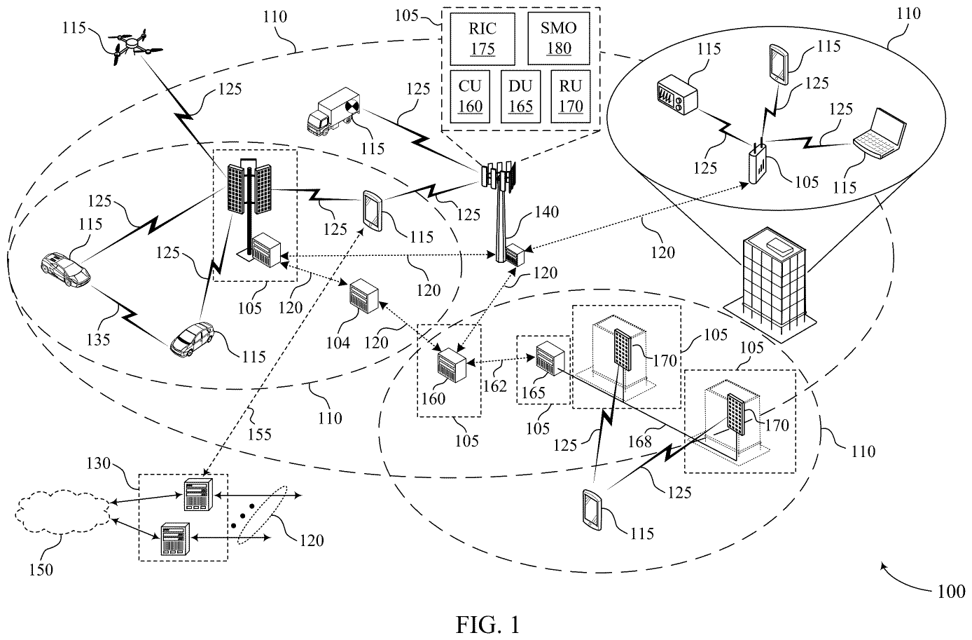

FIG. 1 shows an example of a wireless communications system 100 that supports inbound transport for UE hosted data services in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support inbound transport for UE hosted data services as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, IP connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage NAS functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a UE 115 may serve as a client for a data application while a cloud entity may provide service for the data application. In some applications, the UE 115 and the cloud entity may operate accordingly without regard to whether content for the data application is generated by the cloud entity or by the UE 115 (e.g., social networking applications such as X, Instagram, Tik Tok, or artificial intelligence applications such as ChatGPT). In some other applications, the UE 115 and the cloud entity may operate accordingly even for applications that are peer-to-peer in nature (e.g., multi-user gaming, IMS applications, IP multimedia subsystem (IMS) applications, remote control appliances or drone applications, or the like).

Accordingly, techniques described herein may support the UE 115 hosting services, where computation for application services may be performed at the UE 115 (e.g., rather than at a cloud entity). That is, the UE 115 may operate a service or a server function for applications that serve UEs 115 (e.g., client UEs). In some cases, as described herein, operating a “service” may refer to running a “server function.” For example, a UE hosting a “service” may perform one or more server functions to host the service. Such applications may include social networking applications, multi-user gaming applications, live streaming applications, generative artificial intelligence computation applications, or any combination thereof. The UE 115 may support a UE-based user data repository for a social networking application. In such an application, a client may request data stored at the UE 115 via a domain name system (DNS). The UE 115 may support a distributed P2P application across a set of UEs 115 such as for multi-user gaming (e.g., gaming within social group or a spawned instance of a massive multi-user online game). Similarly, the UE 115 may support a UE-based live broadcast to a group of users. Further, the UE 115 may support a UE based computation service for a generative artificial intelligence application. For example, a client UE 115 may offload generative artificial intelligence processing to the UE 115 (which may have greater processing capability). A set of UEs 115 may perform distributed processing of the generative artificial intelligence application (e.g., an LLM inference). The UE-based generative artificial intelligence model may use data from per devices (e.g., photos, videos, contact information, notes on one or more devices), for model fine tuning (e.g., using retrieval augmented generation) during workload processing.

Techniques described herein may provide one or more benefits to a UE 115 of the wireless communications system 100. For example, these techniques may move processing emphasis from a cloud to a device with higher processing capability (e.g., the UE 115). Such techniques may create more demand for cellular traffic (e.g., due to high processing capability of UEs). Some services may be deployed instantly by connecting the UE 115 to a network entity 105 (e.g., without using cloud-based infrastructure, implementation and deployment). The UE 115 may also use an associated application store (e.g., already in deployment) to obtain and use applications that provide services to clients of the UE 115. For application services that include UE-generated content, techniques described herein may allow the UE 115 to deliver its own generated content to clients (e.g., improving content authenticity and data ownership retention in absence of a third-party cloud entity). For UE-hosted services, these techniques may improve content privacy (e.g., if services are maintained within a trusted group of users). Further, mobile network operators (MNOs) may offer data plans for enhanced service hosting (e.g., at the UE 115). Additionally, or alternatively, UE-hosted services may provide relatively low latency transport for multi-access edge computing (MEC) to client devices connected to a same local user plane function (UPF) (e.g., without using network-side MEC or edge application server (EAS) deployment).

In some wireless communications systems, UE-based service-hosting may involve passing inbound traffic to a service-hosting UE from any remote location and at any time. Further, a service-hosting UE may not be expected to transmit any outbound traffic prior to receiving the inbound traffic. However, inbound traffic may be blocked by security features such as a firewall at some interfaces (e.g., an N6 interface). Some wireless communications systems may support a UE poking a hole in the firewall using a PCP over a user plane. However, such a solution may be insufficient, since a UPF associated with the UE may not support PCP. Further, a PCP client (e.g., a UE) may be configured with an IP address of a PCP server or with a router list. Without the IP address or the router list, the UE may be unable to apply such a solution.

Some wireless communications systems may use an interactive connectivity establishment (ICE) (e.g., as described in IETF RFC 8445) for peer to peer (P2P) connection establishment (e.g., on a U-plane). In some cases, the ICE may work if both of a set of end hosts simultaneously send packets to each other to open up their respective firewalls. Such a solution may involve coordination via a central server. Therefore, the solution may be unable to support hosting services on a UE 115. Some wireless communications systems may attempt to solve these problems by implementing a method in which a UE 115 sends periodic outbound packets to a cloud-based server to keep firewall open for the server. Accordingly, the cloud-based server may send downstream packets at any time. However, such a solution may not support a UE-hosted service (e.g., since inbound traffic may arrive from unknown locations on the Internet).

Further, removing security features for a UE 115 (e.g., punching a hole in a firewall via PCP or by other means) may cause the UE to become vulnerable to security attacks (e.g., denial of service (DOS) or distributed DOS (DDOS) attacks). Moreover, a network entity of a wireless communications system may use a network address translation (NAT) function at an interface associated with a firewall (e.g., an N6 interface). Accordingly, a client device may be unable to discover a public IP address of a service-hosting UE 115 and therefore, the client device may be unable to send packets to the service-hosting UE 115.

As described herein, the wireless communications system 100 may support a UE 115 that performs one or more operations to support hosting services and receiving inbound traffic at the UE 115. For example, the UE 115 may transmit, via a wireless link and to a management entity (e.g., an SMF), a first NAS message including a request to pass inbound traffic (e.g., through a firewall) to the UE 115 from one or more remote locations (e.g., client devices such as a UE 115). In some examples, the first NAS message may further include an indication of a set of transport or traffic characteristics associated with the inbound traffic (e.g., traffic characteristics associated with inbound traffic that is permitted to be passed to the UE 115). The UE 115 may receive, in accordance with transmitting the first NAS message and from the management entity, a second NAS message that indicates whether the request to pass the inbound traffic is accepted. The UE 115 may receive, in accordance with an acceptance of the request, the inbound traffic from the one or more remote locations (e.g., according to the set of transport or traffic characteristics).

Additionally, or alternatively, the UE 115 may transmit, via the wireless link, a first message including a request to communicate with a PCP server used to pass inbound traffic to the UE 115 from one or more remote locations. The UE 115 may receive a second message that indicates an IP address of the PCP server, a domain name of the PCP server, or both. In response to receiving the second message, the UE 115 may transmit, to the PCP server, a PCP request message that indicates a set of transport or traffic characteristics associated with the inbound traffic. Accordingly, the UE 115 may receive the inbound traffic from the one or more remote locations via the PCP server (e.g., according to the set of transport or traffic characteristics).

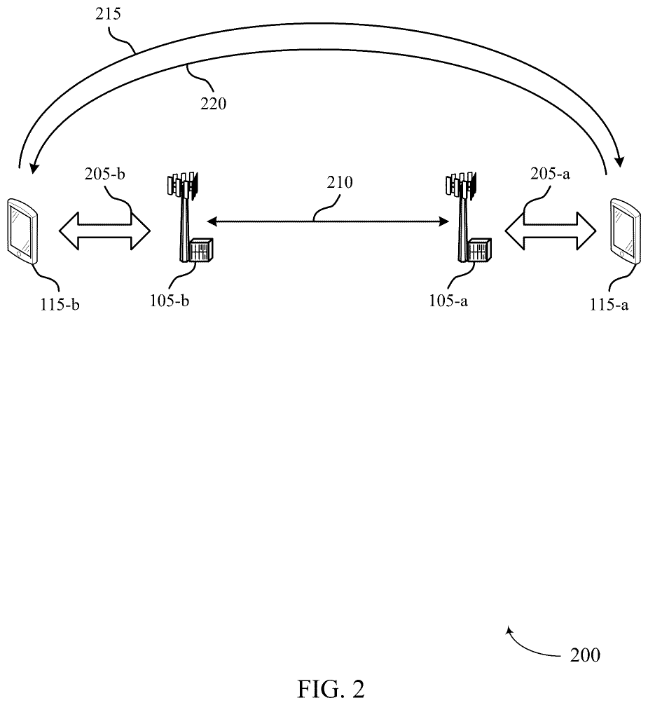

FIG. 2 shows an example of a wireless communications system 200 that supports inbound transport for UE hosted data services in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a and a network entity 105-b), which may be examples of the corresponding devices as described herein.

The UE 115-a may communicate with the network entity 105-a via a wireless communication link 205-a. Similarly, the UE 115-b may communicate with the network entity 105-b via a wireless communication link 205-b. The network entity 105-a may communicate within a core network which is also in communication with the network entity 105-b. For example, the network entity 105-a may communicate with the network entity 105-b over an interface 210 within the core network. The interface 210 may include one or more physical or logical entities as described herein with reference to FIGS. 1, 3, and 4. Accordingly, the UE 115-a may exchange one or more messages with the UE 115-b via one or more entities of the core network, including the network entity 105-a and the network entity 105-b.

In some examples, the UE 115-a may host one or more services, where hosting one or more services may involve the UE 115-a performing computations associated with the service and providing the results to one or more remote locations (e.g., client devices, such as the UE 115-b, IP addresses, IP prefixes, or any combination hereof). As described herein, operating a “service” may refer to running a “server function.” For example, a UE hosting a “service” may perform one or more server functions to host the service. As such, the wireless communications system 200 illustrates a procedure in which a request 215 (e.g., for content, data, or the like associated with a service hosted at the UE 115-a) is transmitted from the UE 115-b to the UE 115-a. The UE 115-b may convey the request 215 to the UE 115-a via the network entity 105-b and the network entity 105-a (e.g., through the interface 210). In response, the UE 115-a may transmit a response 220 (e.g., including the content or data computed at the UE 115-a for the service) to the UE 115-b via the network entity 105-a and the network entity 105-b. Accordingly, the UE 115-a and the UE 115-b may exchange messages over a cellular network. The cellular network may include a radio access network (RAN) entity, an access and mobility management function (AMF), an SMF, a policy control function (PCF), a unified data management (UDM) entity, a user plane function (UPF), a PCP server, or any combination thereof. In some cases, the UE 115-a and the UE 115-b may exchange the messages directly (e.g., without a between node to facilitate transmission).

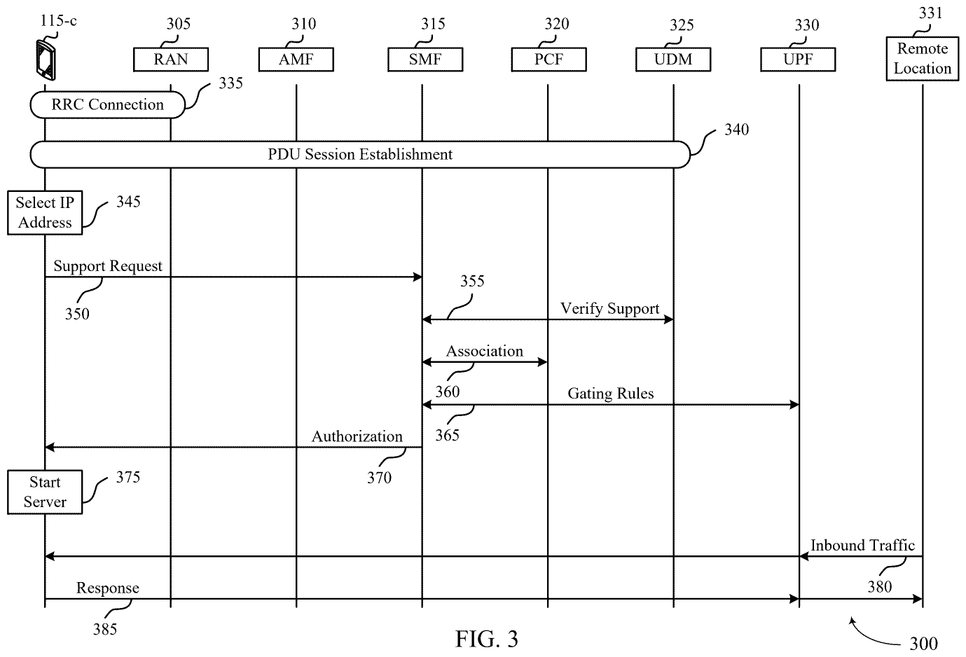

As described herein, the UE 115-a may be an example of a service hosting UE that hosts one or more services. The UE 115-b may be an example of a client UE, a device, or any computing equipment that runs a client function to access the one or more services. The UE 115-b may reside at a remote location. Accordingly, to facilitate such requests 215 and responses 220 associated with services, the UE 115-a may request for the core network (e.g., via a request message) to pass inbound traffic having one or more traffic characteristics (e.g., through a firewall), such that one or more management entities of the core network may pass inbound traffic from the UE 115-b (e.g., remote locations) to the UE 115-a. Such techniques may be further described herein with reference to FIG. 3.

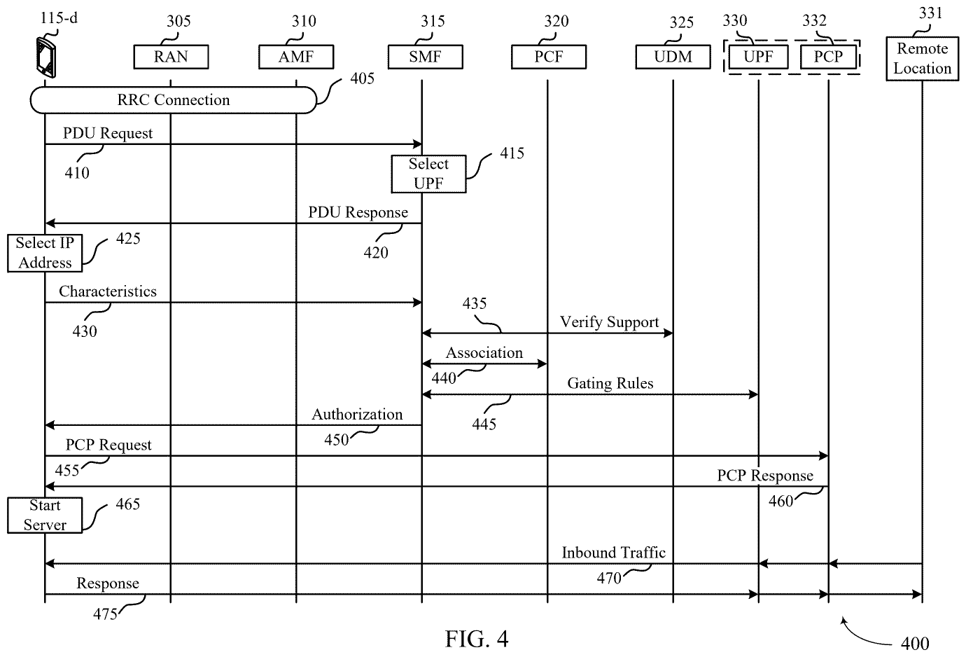

Additionally, or alternatively, the UE 115-a may request for the core network (e.g., via the network entity 105-a) to determine a UPF that supports a PCP server, such that inbound traffic may be passed from the UE 115-b to the UE 115-a via the PCP server. In response, the UE 115-a may receive, from the core network, an IP address corresponding to a PCP server associated with the determined UPF. Accordingly, the UE 115-a may receive inbound traffic having one or more traffic characteristics using the PCP server. Such techniques may be further described herein with reference to FIG. 4.

In some implementations, the UE 115-a may request the core network to gate (e.g., regulate, control) inbound traffic from the UE 115-b to the UE 115-a according to one or more traffic or transport characteristics (e.g., for enhanced security). That is, the core network may allow inbound traffic if the inbound traffic meets the one or more traffic characteristics. The one or more traffic characteristics may include a range of IP addresses, transport protocol port numbers, or both for one or more remote clients (e.g., including the UE 115-b). The one or more traffic characteristics may also include a threshold (e.g., maximum) quantity of permitted inbound traffic attempts within a given time interval in total, a threshold quantity of permitted inbound traffic attempts within a time interval per remote host, or both. Additionally, or alternatively, the one or more traffic characteristics may include a list of restricted remote IP addresses (e.g., a “forbidden list”) for which the core network is to block incoming traffic. In some cases, the one or more traffic characteristics may include one or more durations (e.g., time frames) during which inbound traffic is permitted, during which inbound traffic is not permitted, or both.

In some examples, the UE may request a publicly routable IP address (or multiple IP addresses) to use for hosting one or more services. For example, the UE may request a publicly routable IP address for each of IPv4 and IPv6. The UE may receive the IP address (or the multiple IP addresses) from the network entity 105-a (e.g., from the core network). In some cases, techniques described herein may be implemented during a packet data unit (PDU) session (e.g., traffic characteristics, IP addresses, or the like may be provided with PDU-session granularity).

FIG. 3 shows an example of a process flow 300 that supports inbound transport for UE hosted data services in accordance with one or more aspects of the present disclosure. The process flow 300 includes a UE 115-c and one or more remote locations 331 (e.g., a UE, a client device, an IP address, an IP prefix), which may be examples of the corresponding devices as described herein with respect to FIGS. 1 and 2. The process flow 300 also includes a set of entities within a core network, such as a RAN 305 (e.g., one or more network entities 105 of a RAN 305), an AMF 310, an SMF 315, a PCF 320, a UDM 325, and a UPF 330. In the following description of the process flow 300, the operations between the UE 115-c, the set of entities within the core network, and the remote location 331 may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 335, the UE 115-c may perform an RRC connection establishment procedure to establish a wireless communication link (e.g., an RRC link) with the one or more entities (e.g., a network entity 105 of the RAN 305, the AMF 310, or both). The wireless communication link may provide a communication path between the UE 115-c and the set of entities within the core network.

At 340, the UE 115-c may perform a procedure for establishing a PDU session (e.g., a PDU session establishment procedure) at the UE 115-c. In some examples, as part of the procedure, the UE 115-c may transmit, via the wireless communication link, a message including a request for a publicly routable IP address or a publicly routable IP prefix that is associated with the PDU session. In response, the UE 115-c may receive, as part of the procedure, an indication of the publicly routable IP prefix or the publicly routable IP address for the PDU session (e.g., from the SMF 315).

That is, in some examples, in response to transmitting the message including the request, the SMF 315 may provide the UE 115-c with a publicly routable IP prefix for the PDU session. In such examples, the UE 115-c may proceed to select an IP address for a first service hosted by the UE 115-c at 345. In some other examples, in response to transmitting the message including the request, the SMF 315 may select the publicly routable IP address or IP prefix for the PDU session, where the UE 115-c may use the selected publicly routable IP address or may select one IP address of the IP prefix for the first service hosted at the UE 115-c.

At 345, the UE 115-c may select, in accordance with receiving the indication of the publicly routable IP address for the PDU session, an IP address for a first service (e.g., a UE-hosted data application service) according to the publicly routable IP prefix. In some cases, the UE 115-c may use the selected IP address for communications associated with the first service.

At 350, the UE 115-c may transmit, via the wireless communication link, a first NAS message including a request to pass inbound traffic to the UE 115-c (e.g., punching a hole in a firewall associated with the UE 115-c). The inbound traffic may be associated with the first service hosted at the UE 115-c. For example, the inbound traffic may include a request to establish a transport connection to use the first service, or the inbound traffic may include data associated with the first service, or both. In some examples, the first NAS message may include an indication of the selected IP address for the first service. In some cases, the first NAS message may further include an indication of a set of transport or traffic characteristics associated with the inbound traffic. Additionally, or alternatively, the first NAS message may include an indication for an IP address allocation (e.g., where the IP addresses are publicly routable).

The set of transport or traffic characteristics may include one or more transport characteristics, one or more traffic characteristics, or any combination thereof. For example, the set of transport or traffic characteristics may include an IP address associated with the first service (e.g., an IP address associated with the UE 115-c, a destination address), a transport layer protocol type associated with the first service, a transport layer port identifier associated with the first service, one or more other layer characteristics (e.g., a next set of higher protocol layers), or any combination thereof.

In some cases, the set of transport or traffic characteristics may include a range of supported (e.g., permitted) IP addresses associated with the one or more remote locations 331, a range of supported transport protocol port identifiers associated with the one or more remote locations 331, or both. In some examples, the set of transport or traffic characteristics may include a range of restricted IP addresses that are restricted from communicating inbound traffic (e.g., prohibited from sending traffic to the UE 115-c).

Additionally, or alternatively, the set of transport or traffic characteristics may include one or more first time windows (e.g., first durations) during which the inbound traffic is permitted to be communicated, one or more second time windows (e.g., second durations) during which the inbound traffic is restricted from being communicated, or both.

In some implementations, the set of transport or traffic characteristics may include a first threshold (e.g., maximum) quantity of inbound traffic attempts (or a maximum quantity of inbound traffic) permitted per time interval per remote location of the one or more remote locations. For example, the first threshold quantity may limit a quantity of traffic attempts from each remote location 331 during a particular time interval. Similarly, the set of transport or traffic characteristics may include a second threshold quantity of inbound traffic attempts (or a maximum quantity of inbound traffic) permitted per time interval in total. The second threshold quantity may limit a quantity of traffic attempts from any (e.g., all) remote locations 331 during some time interval.

In some cases, the transmitting the first NAS message may be part of the procedure for establishing the PDU session PDU (e.g., at 340). That is, the procedure may include selecting the IP address (e.g., at 345), transmission of the first NAS message, or both. In some examples, the UE 115-c may transmit multiple NAS messages (e.g., to the SMF 315). Each NAS message of the multiple NAS messages may be for a respective service of a set of services hosted at the UE 115-c, and each service of the set of services may be associated with a respective PDU session. That is, the UE 115-c may transmit each NAS message during a corresponding PDU session. Accordingly, the UE 115-c may perform one or more techniques described herein (e.g., transmitting the multiple NAS messages) to initialize each service of the set of services.

In response to receiving the first NAS message, the SMF 315 may perform one or more operations. For example, at 355, the SMF 315 may verify, with the UDM 325, whether the UE 115-c has a subscription for the support of inbound traffic handling (e.g., verifying whether the UE 115-c is authorized to request the core network to pass inbound traffic based on the subscription). For example, the SMF 315 may transmit, to the UDM 325, a verification message to verify whether the UE 115-c is associated with the subscription to pass the inbound traffic. In some cases, the SMF 315 may receive, from the UDM 325, a data management message that indicates that the UE 115-c permits passing the inbound traffic.

At 360, the SMF 315 may establish (e.g., create) a charging association for the first service in accordance with verifying that the UE 115-c is associated with the subscription to host the first service (e.g., through an exchange of one or more messages with the PCF 320). For example, the SMF 315 may request to create a charging record associated with the UE 115-c for the PCF 320. The charging association (e.g., charging record) may indicate that the UE 115-c supports inbound traffic handling (e.g., permits inbound traffic handling).

At 365, the SMF 315 may generate, in accordance with the set of traffic or transport characteristics, a configuration associated with passing the inbound traffic. That is, the configuration may include a set of rules, regulations, or the like associated with controlling inbound traffic based on the set of traffic characteristics. In some cases, the SMF 315 and the UPF 330 may generate the configuration through an exchange of messages. In some examples, the SMF 315 may transmit, to the UPF 330, a regulation request for the UPF 330 to regulate (e.g., gate) the inbound traffic in accordance with the configuration (e.g., according to a set of gating rules). The regulation request may include an indication of the configuration. That is, the SMF 315 may request the UPF 330 to pass inbound traffic that has (e.g., matches) the characteristics provided by the UE 115-c. Accordingly, the UPF 330 may regulate the inbound traffic to the UE 115-c from one or more remote locations 331.

At 370, the SMF 315 may transmit, to the UE 115-c, a second NAS message that indicates that the request to pass the inbound traffic is accepted (e.g., granted) in accordance with the UE 115-c being associated with the subscription (e.g., the second NAS message may indicate an authorization of the request). In some cases, the second NAS message may indicate that the request is rejected if the UE 115-c is not associated with the subscription. Transmitting the second NAS message may be responsive to establishing the charging association (e.g., at 360), generating the configuration (e.g., at 365, and may be in accordance with the data management message (e.g., received at 355). The UE 115-c may receive the second NAS message that indicates whether the request to pass the inbound traffic is accepted.

At 375, the UE 115-c may initialize (e.g., start) one or more server functions associated with the first service for the selected IP address. In some cases, the UE 115-c may initialize the one or more server functions in accordance with the acceptance of the request to pass the inbound traffic (e.g., if the request was granted). As described herein, operating a “service” may refer to running a “server function.” For example, a UE hosting a “service” may perform one or more server functions to host the service.

At 380, the UE 115-c may receive the inbound traffic from one or more remote locations 331 in accordance with an acceptance of the request. In some cases, the UE 115-c may receive the inbound traffic based on the inbound traffic being in accordance with the set of transport or traffic characteristics (e.g., receiving inbound traffic that has or matches the set of transport or traffic characteristics). In some examples, the UE 115-c may receive the inbound traffic in accordance with initializing the one or more server functions.

At 385, the UE 115-c may transmit, to the one or more remote locations 331, one or more response messages in response to the inbound traffic. Each of the one or more remote locations 331 may correspond to a respective IP address, a respective IP prefix, one or more client devices (e.g., the remote location 331), or any combination thereof. For example, the inbound traffic may originate from the one or more remote locations 331, each of which may be associated with a respective IP address, a respective IP prefix, or both that satisfies the one or more traffic or transport characteristics.

FIG. 4 shows an example of a process flow 400 that supports inbound transport for UE hosted data services in accordance with one or more aspects of the present disclosure. The process flow 400 includes a UE 115-d and one or more remote locations 331, which may be examples of the corresponding devices as described herein with respect to FIGS. 1 and 2. The process flow 400 also includes a set of entities within a core network such as a RAN 305 (e.g., one or more network entities 105 of a RAN 305), an AMF 310, an SMF 315, a PCF 320, a UDM 325 (e.g., a UDM entity), a UPF 330, and a PCP server 332. In the following description of the process flow 400, the operations between the UE 115-d, the set of entities within the core network, and the remote locations 331 may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-d may perform an RRC connection establishment procedure to establish a wireless communication link (e.g., an RRC link) with the one or more entities (e.g., a network entity 105 of the RAN 305, the AMF 310, or both). The wireless communication link may provide a communication path between the UE 115-d and the set of entities within the core network.

At 410, the UE 115-d may begin a procedure for establishing a PDU session (e.g., a PDU session establishment procedure). For example, the UE 115-d may transmit, via the wireless communications link (e.g., to the SMF 315), a first message including a request to communicate with a PCP server used (e.g., configured) to pass inbound traffic to the UE 115-d (e.g., a PCP server that supports passing inbound traffic to the UE 115-d). For example, the UE 115-d may request support of the PCP server for inbound traffic. The inbound traffic may be associated with a first service (e.g., a data application service) hosted at the UE. The first message may be or may include a PDU session establishment request. In some cases, the UE 115-d may transmit, via the first message, a second request for a set of publicly routable IP addresses (e.g., including the IP address of the PCP server). In some cases, the second request may be for the SMF 315 to obtain the publicly routable IP addresses for the PDU session.

At 415, as part of the procedure for establishing the PDU session, the SMF 315 may select a UPF that supports the PCP server (e.g., the UPF 330 supporting the PCP server 332). In some cases, the SMF 315 may receive, from the UPF 330, an IP address message including the IP address of the PCP server. Accordingly, the SMF 315 may obtain (e.g., receive) an IP address associated with the PCP server 332 (e.g., a PCP server function).

In some cases, the SMF 315 may use a network repository function (NRF) for selecting the UPF 330. In such cases, the NRF may provide information to the SMF 315 about a PCP support capability of the UPF 330. In some examples, at a time that the UPF 330 registers at the NRF, the UPF 330 may include an indication of the PCP support capability (e.g., the NRF may have access to a record of the PCP support capability, and thus may provide the record to the SMF 315). In some implementations, the SMF 315 may request the IP address associated with the PCP server 332 from the UPF 330. In response, the UPF 330 may transmit the IP address to the SMF 315. The SMF 315 may similarly determine a domain name (e.g., a fully qualified domain name (FQDN) of the PCP server 332.

In some implementations, the PCP server 332 may be collocated with the UPF 330 (e.g., be located at a same entity or server). In some other implementations, the UPF 330 and the PCP server 332 may not be collocated, but may be in communication, such that the UPF 330 and the PCP server 332 may facilitate the communication of the inbound traffic to the UE 115-d.

At 420, as part of the procedure for establishing the PDU session, the UE 115-d receive a second message (e.g., a PDU session establishment response) via the wireless communications link (e.g., from the SMF 315) in accordance with receiving the first message. The second message may indicate the IP address of the PCP server 332, the domain name of the PCP server 332, or both. In some implementations, the UE 115-d may receive, via the second message (e.g., from the SMF 315), a publicly routable IP prefix for the PDU session established as part of the PDU session establishment procedure. That is, the UE 115-d may receive, via the second message, the IP address of the PCP server 332, the domain name of the PCP server 332, the publicly routable IP prefix for the PDU session, or any combination thereof.

At 425, the UE 115-d may select, in accordance with receiving the indication, an IP address for a first service (e.g., a UE-hosted data application service) according to the publicly routable IP prefix received at 420. In some cases, the UE 115-d may use the selected IP address for communications associated with the first service. At 430, the UE 115-d may transmit, via the wireless communication link, a first NAS message (or other type of message) including an indication of a set of transport or traffic characteristics associated with the inbound traffic. The set of transport or traffic characteristics may include one or more transport characteristics, one or more traffic characteristics, or any combination thereof, as described herein with reference to FIG. 3.

In response to receiving the first NAS message, the SMF 315 may perform one or more operations. At 435, at 440, and at 445, the SMF 315 may perform operations similar to operations performed at 355, at 360, and at 365, respectively, as described herein with reference to FIG. 3. For example, at 435, the SMF 315 may verify, with the UDM 325, whether the UE 115-d has a subscription for the support of inbound traffic handling. At 440, the SMF 315 may establish (e.g., create) a charging association for the first service in accordance with verifying that the UE 115-d is associated with the subscription to host the first service. At 445, the SMF 315 may generate, in accordance with the set of traffic characteristics, a configuration associated with passing the inbound traffic (e.g., punching a hole in a firewall associated with the UE 115-d). In some examples, the SMF 315 may transmit, to the UPF 330, a regulation request for the UPF 330 to regulate (e.g., gate) the inbound traffic in accordance with the configuration (e.g., according to a set of gating rules). The UPF 330 may regulate the inbound traffic to the UE 115-d from one or more remote locations (e.g., client devices such as the remote location 331).

At 450, the SMF 315 may transmit, to the UE 115-d, a second NAS message (or another type of message) that indicates that a request to pass the inbound traffic is accepted (e.g., granted) in accordance with the UE 115-d being associated with the subscription (e.g., the second NAS message may indicate an authorization of the request). In some cases, the second NAS message may indicate that the request is rejected if the UE 115-d is not associated with the subscription. Transmitting the second NAS message may be responsive to establishing the charging association (e.g., at 440), generating the configuration (e.g., at 445, and may be in accordance with the data management message (e.g., received at 445). In some cases, transmitting the second NAS message may be in accordance with receiving the IP address message.

At 455, the UE 115-d may transmit a PCP request message to the PCP server 332 in accordance with receiving the second message. The PCP request message may indicate the set of transport or traffic characteristics associated with the inbound traffic. For example, the set of transport or traffic characteristics may include an IP address associated with the first service (e.g., an IP address of the UE 115-d, a destination address), a transport layer protocol type associated with the first service, a transport layer port identifier associated with the first service, other upper layer characteristics, or any combination thereof. At 460, the UE 115-d may receive, in response to the PCP request message, a PCP acknowledgment message that indicates an acceptance (e.g., an acknowledgment) of the PCP request message (e.g., based on a capability of the UE 115-d, a capability of the PCP server 332, a capability of the UPF 330, or any combination thereof).

At 465, the UE 115-d may initialize one or more server functions associated with the first service. The first service may be associated with the IP address selected by the UE, the IP address of the PCP server 332, or both. As described herein, operating a “service” may refer to running a “server function.” For example, a UE hosting a “service” may perform one or more server functions to host the service. At 470, the UE 115-d may receive the inbound traffic from one or more remote locations 331 according to the set of transport or traffic characteristics and via the PCP server 332. The UE 115-d may communicate with the one or more remote locations via the UPF 330, the PCP server 332, or both. In some cases, the UE 115-d may receive the inbound traffic in accordance with the acceptance of the PCP request message. In some examples, the UE 115-d may receive the inbound traffic in accordance with initializing the one or more server functions. At 475, the UE 115-d may transmit, to the one or more remote locations 331, one or more response messages in response to the inbound traffic.

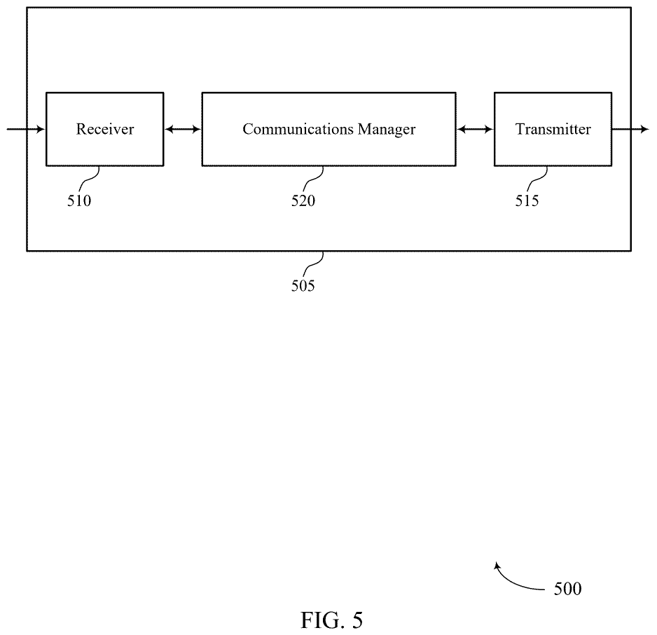

FIG. 5 shows a block diagram 500 of a device 505 that supports inbound transport for UE hosted data services in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to inbound transport for UE hosted data services). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to inbound transport for UE hosted data services). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of inbound transport for UE hosted data services as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting, via a wireless communications link, a first NAS message including a request to pass inbound traffic to the UE, where the inbound traffic is associated with a first service hosted at the UE. The communications manager 520 is capable of, configured to, or operable to support a means for receiving, in accordance with transmitting the first NAS message, a second NAS message that indicates whether the request to pass the inbound traffic is accepted. The communications manager 520 is capable of, configured to, or operable to support a means for receiving, in accordance with an acceptance of the request, the inbound traffic from one or more remote locations.

Additionally, or alternatively, the communications manager 520 may support wireless communications in accordance with examples as disclosed herein. For example, the communications manager 520 is capable of, configured to, or operable to support a means for transmitting, via a wireless communications link, a first message including a request to communicate with a PCP server used to pass inbound traffic to the UE. The communications manager 520 is capable of, configured to, or operable to support a means for receiving, via the wireless communications link and in accordance with receiving the first message, a second message that indicates an IP address of the PCP server, a domain name of the PCP server, or both, where the inbound traffic is associated with a first service hosted at the UE. The communications manager 520 is capable of, configured to, or operable to support a means for transmitting, to the PCP server and in accordance with receiving the second message, a PCP request message that indicates a set of transport or traffic characteristics associated with the inbound traffic. The communications manager 520 is capable of, configured to, or operable to support a means for receiving the inbound traffic from one or more remote locations according to the set of transport or traffic characteristics and via the PCP server.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for inbound transport for UE hosted data services, which may result in reduced processing for some devices, reduced power consumption, more efficient utilization of communication resources, increased data security, and more efficient service hosting capability, among other advantages.

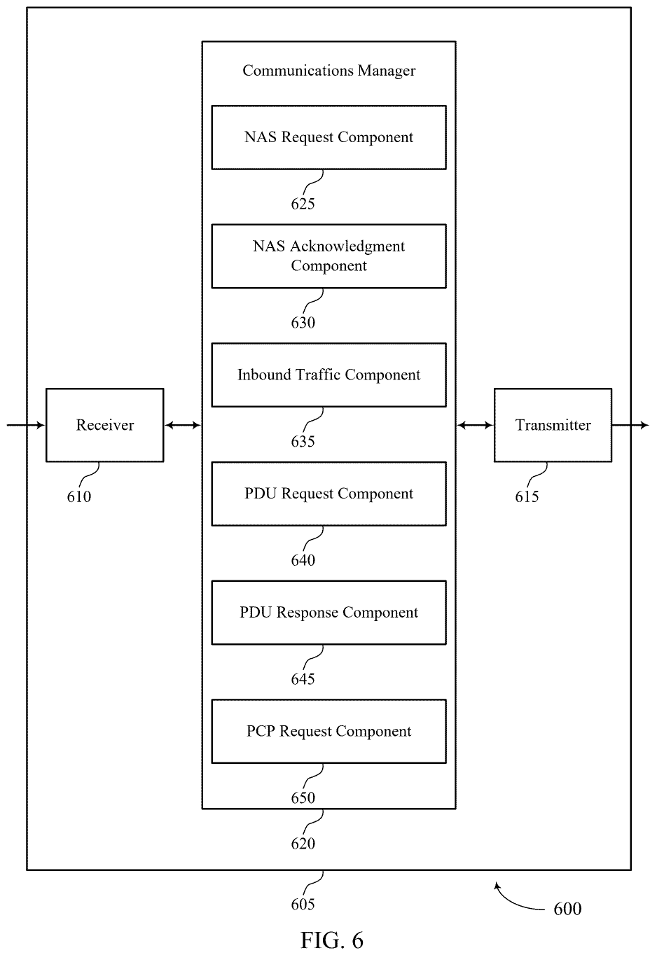

FIG. 6 shows a block diagram 600 of a device 605 that supports inbound transport for UE hosted data services in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to inbound transport for UE hosted data services). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inbound transport for UE hosted data services). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of inbound transport for UE hosted data services as described herein. For example, the communications manager 620 may include a NAS request component 625, a NAS acknowledgment component 630, an inbound traffic component 635, a PDU request component 640, a PDU response component 645, a PCP request component 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The NAS request component 625 is capable of, configured to, or operable to support a means for transmitting, via a wireless communications link, a first NAS message including a request to pass inbound traffic to the UE, where the inbound traffic is associated with a first service hosted at the UE. The NAS acknowledgment component 630 is capable of, configured to, or operable to support a means for receiving, in accordance with transmitting the first NAS message, a second NAS message that indicates whether the request to pass the inbound traffic is accepted. The inbound traffic component 635 is capable of, configured to, or operable to support a means for receiving, in accordance with an acceptance of the request, the inbound traffic from one or more remote locations.

Additionally, or alternatively, the communications manager 620 may support wireless communications in accordance with examples as disclosed herein. The PDU request component 640 is capable of, configured to, or operable to support a means for transmitting, via a wireless communications link, a first message including a request to communicate with a PCP server used to pass inbound traffic to the UE. The PDU response component 645 is capable of, configured to, or operable to support a means for receiving, via the wireless communications link and in accordance with receiving the first message, a second message that indicates an IP address of the PCP server, a domain name of the PCP server, or both, where the inbound traffic is associated with a first service hosted at the UE. The PCP request component 650 is capable of, configured to, or operable to support a means for transmitting, to the PCP server and in accordance with receiving the second message, a PCP request message that indicates a set of transport or traffic characteristics associated with the inbound traffic. The inbound traffic component 635 is capable of, configured to, or operable to support a means for receiving the inbound traffic from one or more remote locations according to the set of transport or traffic characteristics and via the PCP server.

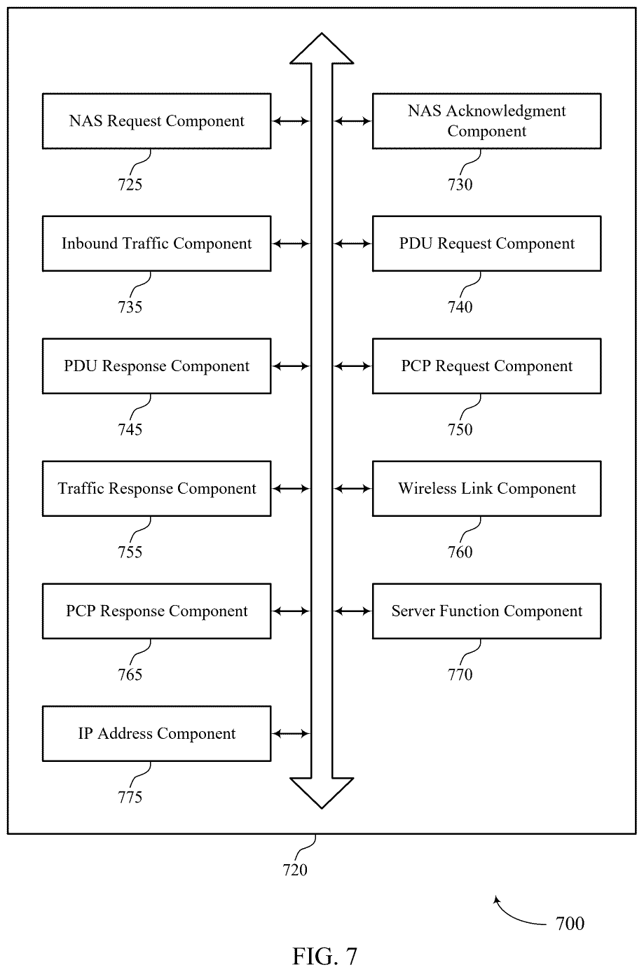

FIG. 7 shows a block diagram 700 of a communications manager 720 that supports inbound transport for UE hosted data services in accordance with one or more aspects of the present disclosure. The communications manager 720 may be an example of aspects of a communications manager 520, a communications manager 620, or both, as described herein. The communications manager 720, or various components thereof, may be an example of means for performing various aspects of inbound transport for UE hosted data services as described herein. For example, the communications manager 720 may include a NAS request component 725, a NAS acknowledgment component 730, an inbound traffic component 735, a PDU request component 740, a PDU response component 745, a PCP request component 750, a traffic response component 755, a wireless link component 760, a PCP response component 765, a server function component 770, an IP address component 775, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The NAS request component 725 is capable of, configured to, or operable to support a means for transmitting, via a wireless communications link, a first NAS message including a request to pass inbound traffic to the UE, where the inbound traffic is associated with a first service hosted at the UE. The NAS acknowledgment component 730 is capable of, configured to, or operable to support a means for receiving, in accordance with transmitting the first NAS message, a second NAS message that indicates whether the request to pass the inbound traffic is accepted. The inbound traffic component 735 is capable of, configured to, or operable to support a means for receiving, in accordance with an acceptance of the request, the inbound traffic from one or more remote locations.

In some examples, the PDU request component 740 is capable of, configured to, or operable to support a means for transmitting, via the wireless communications link and as part of a procedure for establishing a PDU session, a message including a request for a publicly routable IP address or a publicly routable IP prefix. In some examples, the PDU response component 745 is capable of, configured to, or operable to support a means for receiving, in response to the message and as part of the procedure, an indication of the publicly routable IP prefix or the publicly routable IP address for the PDU session, where transmitting the first NAS message is in accordance with receiving the indication.

In some examples, the IP address component 775 is capable of, configured to, or operable to support a means for selecting, in accordance with receiving the indication, an IP address for the first service according to the publicly routable IP prefix, where the first NAS message includes an indication of the selected IP address for the first service.

In some examples, the server function component 770 is capable of, configured to, or operable to support a means for initializing, in accordance with the acceptance of the request to pass the inbound traffic, one or more server functions associated with the first service for the selected IP address, where receiving the inbound traffic is in accordance with initializing the one or more server functions.

In some examples, the traffic response component 755 is capable of, configured to, or operable to support a means for transmitting, to the one or more remote locations, one or more response messages in response to the inbound traffic.

In some examples, each of the one or more remote locations corresponds to a respective IP address, a respective IP prefix, or any combination thereof.

In some examples, the first NAS message further includes an indication of a set of transport or traffic characteristics associated with the inbound traffic. In some examples, receiving the inbound traffic is based on the inbound traffic being in accordance with the set of transport or traffic characteristics.

In some examples, the set of transport or traffic characteristics includes an IP address associated with the first service, a transport layer protocol type associated with the first service, a transport layer port identifier associated with the first service, or any combination thereof.

In some examples, the set of transport or traffic characteristics includes a range of supported IP addresses associated with the one or more remote locations associated with the inbound traffic, a range of supported transport protocol port identifiers associated with the one or more remote locations, or both.

In some examples, the set of transport or traffic characteristics includes a range of restricted IP addresses that are restricted from communicating inbound traffic.

In some examples, the set of transport or traffic characteristics includes one or more first time windows during which the inbound traffic is permitted to be communicated, one or more second time windows during which the inbound traffic is restricted from being communicated, or both.

In some examples, the set of transport or traffic characteristics includes a first threshold quantity of inbound traffic attempts permitted per time interval per remote location of the one or more remote locations, a second threshold quantity of inbound traffic attempts permitted per time interval in total, or both.

Additionally, or alternatively, the communications manager 720 may support wireless communications in accordance with examples as disclosed herein. The PDU request component 740 is capable of, configured to, or operable to support a means for transmitting, via a wireless communications link, a first message including a request to communicate with a PCP server used to pass inbound traffic to the UE. The PDU response component 745 is capable of, configured to, or operable to support a means for receiving, via the wireless communications link and in accordance with receiving the first message, a second message that indicates an IP address of the PCP server, a domain name of the PCP server, or both, where the inbound traffic is associated with a first service hosted at the UE. The PCP request component 750 is capable of, configured to, or operable to support a means for transmitting, to the PCP server and in accordance with receiving the second message, a PCP request message that indicates a set of transport or traffic characteristics associated with the inbound traffic. In some examples, the inbound traffic component 735 is capable of, configured to, or operable to support a means for receiving the inbound traffic from one or more remote locations according to the set of transport or traffic characteristics and via the PCP server.

In some examples, the wireless link component 760 is capable of, configured to, or operable to support a means for establishing the wireless communications link with a management entity of a core network associated with the UE, where the wireless communications link includes a radio resource control connection.

In some examples, the PDU request component 740 is capable of, configured to, or operable to support a means for transmitting, via the first message, a second request for a set of publicly routable IP addresses including the IP address of the PCP server, where receiving the second message is in accordance with transmitting the second request.

In some examples, the PDU response component 745 is capable of, configured to, or operable to support a means for receiving, via the second message, a publicly routable IP prefix for a PDU session, where the IP address of the PCP server is in accordance with the publicly routable IP prefix.

In some examples, the PCP response component 765 is capable of, configured to, or operable to support a means for receiving, in response to the PCP request message, a PCP acknowledgment message that indicates an acceptance of the PCP request message, where receiving the inbound traffic is in accordance with the acceptance of the PCP request message.

In some examples, the server function component 770 is capable of, configured to, or operable to support a means for initializing one or more server functions associated with the first service for the IP address of the PCP server, where receiving the inbound traffic is in accordance with initializing the one or more server functions.

In some examples, the traffic response component 755 is capable of, configured to, or operable to support a means for transmitting, to the one or more remote locations, one or more response messages in response to the inbound traffic.

In some examples, the set of transport or traffic characteristics includes an IP address associated with the first service, a transport layer protocol type associated with the first service, a transport layer port identifier associated with the first service, or any combination thereof.

In some examples, the set of transport or traffic characteristics includes a range of supported IP addresses associated with the one or more remote locations, a range of supported transport protocol port identifiers associated with the one or more remote locations, or both.

In some examples, the set of transport or traffic characteristics includes a range of restricted IP addresses that are restricted from communicating inbound traffic.

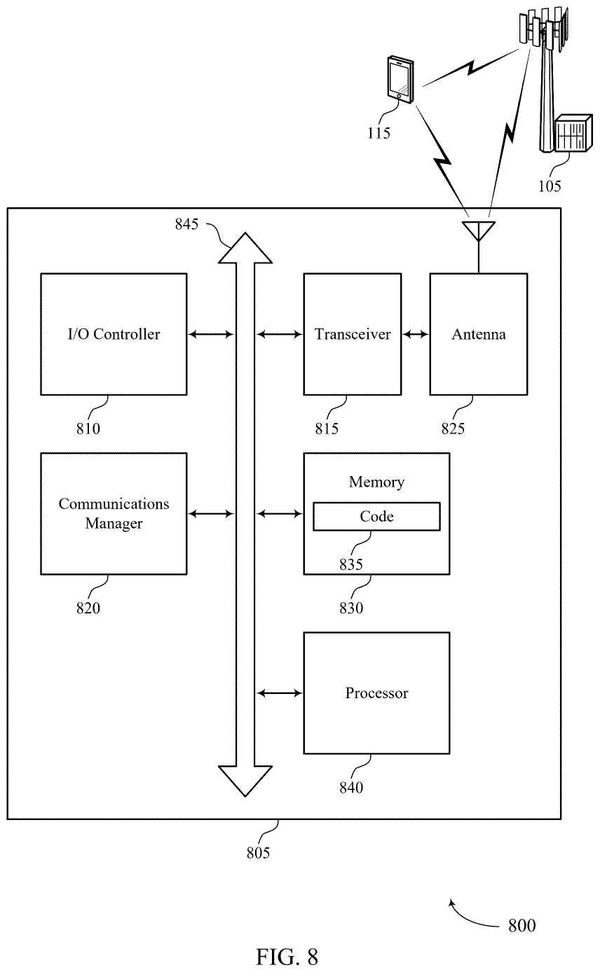

FIG. 8 shows a diagram of a system 800 including a device 805 that supports inbound transport for UE hosted data services in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting inbound transport for UE hosted data services). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting, via a wireless communications link, a first NAS message including a request to pass inbound traffic to the UE, where the inbound traffic is associated with a first service hosted at the UE. The communications manager 820 is capable of, configured to, or operable to support a means for receiving, in accordance with transmitting the first NAS message, a second NAS message that indicates whether the request to pass the inbound traffic is accepted. The communications manager 820 is capable of, configured to, or operable to support a means for receiving, in accordance with an acceptance of the request, the inbound traffic from one or more remote locations.

Additionally, or alternatively, the communications manager 820 may support wireless communications in accordance with examples as disclosed herein. For example, the communications manager 820 is capable of, configured to, or operable to support a means for transmitting, via a wireless communications link, a first message including a request to communicate with a PCP server used to pass inbound traffic to the UE. The communications manager 820 is capable of, configured to, or operable to support a means for receiving, via the wireless communications link and in accordance with receiving the first message, a second message that indicates an IP address of the PCP server, a domain name of the PCP server, or both, where the inbound traffic is associated with a first service hosted at the UE. The communications manager 820 is capable of, configured to, or operable to support a means for transmitting, to the PCP server and in accordance with receiving the second message, a PCP request message that indicates a set of transport or traffic characteristics associated with the inbound traffic. The communications manager 820 is capable of, configured to, or operable to support a means for receiving the inbound traffic from one or more remote locations according to the set of transport or traffic characteristics and via the PCP server.

By including or configuring the communications manager 820 in accordance with examples as described herein, the device 805 may support techniques for inbound transport for UE hosted data services, which may result in improved communication reliability, reduced latency, improved user experience related to reduced processing for some devices, reduced power consumption, more efficient utilization of communication resources, increased data security, improved coordination between devices, improved utilization of processing capability, and more efficient service hosting capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of inbound transport for UE hosted data services as described herein, or the at least one processor 840 and the at least one memory 830 may be otherwise configured to, individually or collectively, perform or support such operations.

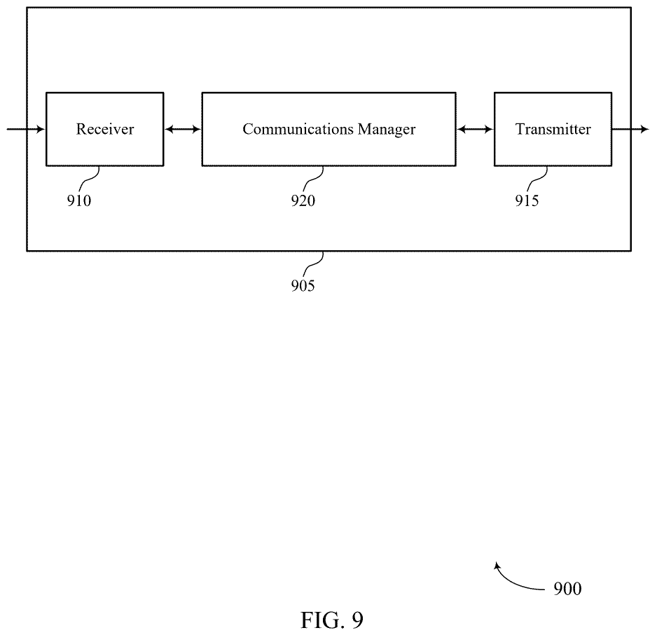

FIG. 9 shows a block diagram 900 of a device 905 that supports inbound transport for UE hosted data services in accordance with one or more aspects of the present disclosure. The device 905 may be an example of aspects of a management entity as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of inbound transport for UE hosted data services as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, via a wireless communications link and from a UE, a first NAS message including a request to pass inbound traffic to the UE, where the inbound traffic is associated with a first service hosted at the UE. The communications manager 920 is capable of, configured to, or operable to support a means for transmitting, to a second management entity, a verification message to verify whether the UE is associated with a subscription to pass the inbound traffic. The communications manager 920 is capable of, configured to, or operable to support a means for transmitting, to the UE, a second NAS message that indicates that the request to pass the inbound traffic is accepted in accordance with the UE being associated with the subscription.

Additionally, or alternatively, the communications manager 920 may support wireless communications in accordance with examples as disclosed herein. For example, the communications manager 920 is capable of, configured to, or operable to support a means for receiving, via a wireless communications link and from a UE, a first message including a request to communicate with a PCP server used to pass inbound traffic to the UE. The communications manager 920 is capable of, configured to, or operable to support a means for transmitting, via the wireless communications link and in accordance with receiving the first message, a second message that indicates an IP address of the PCP server, a domain name of the PCP server, or both, where the inbound traffic is associated with a first service hosted at the UE. The communications manager 920 is capable of, configured to, or operable to support a means for receiving, via the wireless communications link, a first NAS message that indicates a set of transport or traffic characteristics associated with the inbound traffic. The communications manager 920 is capable of, configured to, or operable to support a means for transmitting, to the UE, a second NAS message that indicates that the request to communicate with the PCP server is accepted in accordance with the UE being associated with a subscription to pass the inbound traffic.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for inbound transport for UE hosted data services, which may result in reduced processing for some devices, reduced power consumption, more efficient utilization of communication resources, increased data security, and more efficient service hosting capability, among other advantages.

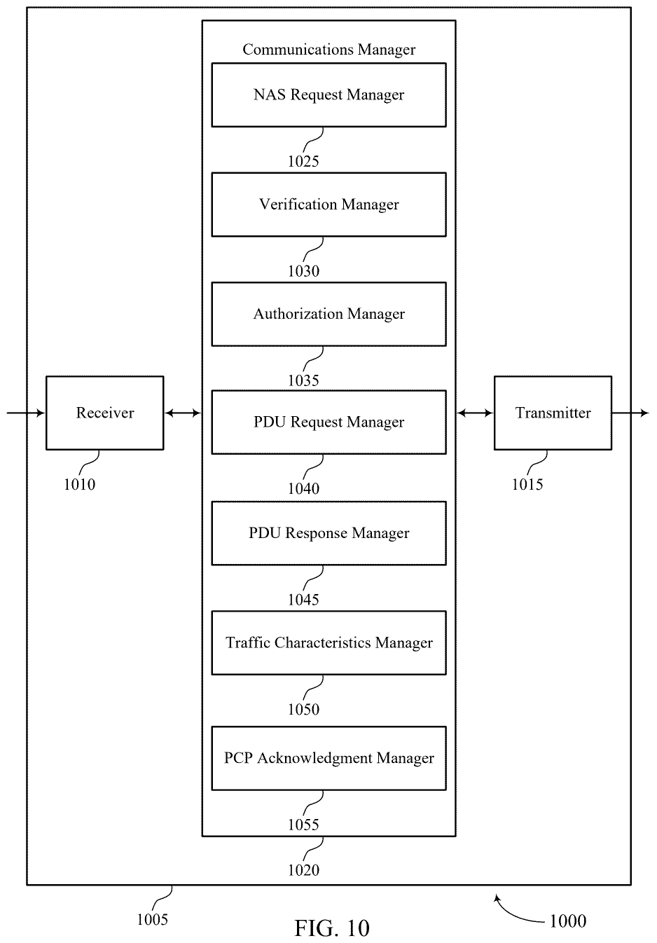

FIG. 10 shows a block diagram 1000 of a device 1005 that supports inbound transport for UE hosted data services in accordance with one or more aspects of the present disclosure. The device 1005 may be an example of aspects of a device 905 or a management entity as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of inbound transport for UE hosted data services as described herein. For example, the communications manager 1020 may include a NAS request manager 1025, a verification manager 1030, an authorization manager 1035, a PDU request manager 1040, a PDU response manager 1045, a traffic characteristics manager 1050, a PCP acknowledgment manager 1055, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The NAS request manager 1025 is capable of, configured to, or operable to support a means for receiving, via a wireless communications link and from a UE, a first NAS message including a request to pass inbound traffic to the UE, where the inbound traffic is associated with a first service hosted at the UE. The verification manager 1030 is capable of, configured to, or operable to support a means for transmitting, to a second management entity, a verification message to verify whether the UE is associated with a subscription to pass the inbound traffic. The authorization manager 1035 is capable of, configured to, or operable to support a means for transmitting, to the UE, a second NAS message that indicates that the request to pass the inbound traffic is accepted in accordance with the UE being associated with the subscription.

Additionally, or alternatively, the communications manager 1020 may support wireless communications in accordance with examples as disclosed herein. The PDU request manager 1040 is capable of, configured to, or operable to support a means for receiving, via a wireless communications link and from a UE, a first message including a request to communicate with a PCP server used to pass inbound traffic to the UE. The PDU response manager 1045 is capable of, configured to, or operable to support a means for transmitting, via the wireless communications link and in accordance with receiving the first message, a second message that indicates an IP address of the PCP server, a domain name of the PCP server, or both, where the inbound traffic is associated with a first service hosted at the UE. The traffic characteristics manager 1050 is capable of, configured to, or operable to support a means for receiving, via the wireless communications link, a first NAS message that indicates a set of transport or traffic characteristics associated with the inbound traffic. The PCP acknowledgment manager 1055 is capable of, configured to, or operable to support a means for transmitting, to the UE, a second NAS message that indicates that the request to communicate with the PCP server is accepted in accordance with the UE being associated with a subscription to pass the inbound traffic.

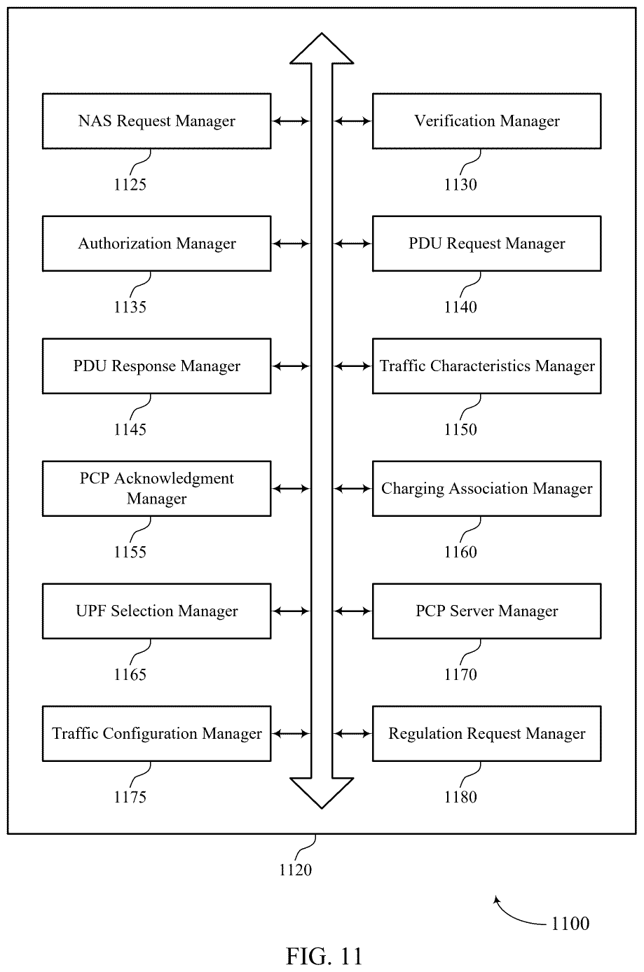

FIG. 11 shows a block diagram 1100 of a communications manager 1120 that supports inbound transport for UE hosted data services in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of inbound transport for UE hosted data services as described herein. For example, the communications manager 1120 may include a NAS request manager 1125, a verification manager 1130, an authorization manager 1135, a PDU request manager 1140, a PDU response manager 1145, a traffic characteristics manager 1150, a PCP acknowledgment manager 1155, a charging association manager 1160, a UPF selection manager 1165, a PCP server manager 1170, a traffic configuration manager 1175, a regulation request manager 1180, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The NAS request manager 1125 is capable of, configured to, or operable to support a means for receiving, via a wireless communications link and from a UE, a first NAS message including a request to pass inbound traffic to the UE, where the inbound traffic is associated with a first service hosted at the UE. The verification manager 1130 is capable of, configured to, or operable to support a means for transmitting, to a second management entity, a verification message to verify whether the UE is associated with a subscription to pass the inbound traffic. The authorization manager 1135 is capable of, configured to, or operable to support a means for transmitting, to the UE, a second NAS message that indicates that the request to pass the inbound traffic is accepted in accordance with the UE being associated with the subscription.

In some examples, the verification manager 1130 is capable of, configured to, or operable to support a means for receiving, from the second management entity, a data management message that indicates that the UE permits passing the inbound traffic, where transmitting the second NAS message is in accordance with the data management message.

In some examples, the charging association manager 1160 is capable of, configured to, or operable to support a means for establishing a charging association for the first service in accordance with verifying that the UE is associated with the subscription to host the first service, where transmitting the second NAS message is responsive to establishing the charging association.

In some examples, the first NAS message further includes an indication of a set of traffic characteristics associated with passing the inbound traffic.

In some examples, the traffic configuration manager 1175 is capable of, configured to, or operable to support a means for generating, in accordance with the set of traffic characteristics, a configuration associated with passing the inbound traffic, where transmitting the second NAS message is responsive to generating the configuration.

In some examples, the regulation request manager 1180 is capable of, configured to, or operable to support a means for transmitting, to a user plane function, a regulation request for the user plane function to regulate the inbound traffic in accordance with the configuration, where the regulation request includes an indication of the configuration.

Additionally, or alternatively, the communications manager 1120 may support wireless communications in accordance with examples as disclosed herein. The PDU request manager 1140 is capable of, configured to, or operable to support a means for receiving, via a wireless communications link and from a UE, a first message including a request to communicate with a PCP server used to pass inbound traffic to the UE. The PDU response manager 1145 is capable of, configured to, or operable to support a means for transmitting, via the wireless communications link and in accordance with receiving the first message, a second message that indicates an IP address of the PCP server, a domain name of the PCP server, or both, where the inbound traffic is associated with a first service hosted at the UE. The traffic characteristics manager 1150 is capable of, configured to, or operable to support a means for receiving, via the wireless communications link, a first NAS message that indicates a set of transport or traffic characteristics associated with the inbound traffic. The PCP acknowledgment manager 1155 is capable of, configured to, or operable to support a means for transmitting, to the UE, a second NAS message that indicates that the request to communicate with the PCP server is accepted in accordance with the UE being associated with a subscription to pass the inbound traffic.

In some examples, the UPF selection manager 1165 is capable of, configured to, or operable to support a means for selecting a user plane function that supports the PCP server. In some examples, the PCP server manager 1170 is capable of, configured to, or operable to support a means for receiving, from the user plane function, an IP address message including the IP address of the PCP server, where transmitting the second NAS message is in accordance with receiving the IP address message.

In some examples, the verification manager 1130 is capable of, configured to, or operable to support a means for exchanging one or more messages with a second management entity to verify whether the UE is associated with the subscription to pass the inbound traffic, where transmitting the second NAS message is in accordance with the UE being associated with the subscription.

In some examples, the charging association manager 1160 is capable of, configured to, or operable to support a means for establishing a charging association for the first service in accordance with verifying that the UE is associated with the subscription to host the first service, where transmitting the second NAS message is responsive to establishing the charging association.

In some examples, the traffic configuration manager 1175 is capable of, configured to, or operable to support a means for generating, in accordance with the set of transport or traffic characteristics, a configuration associated with passing the inbound traffic. In some examples, the regulation request manager 1180 is capable of, configured to, or operable to support a means for transmitting, to a user plane function, a regulation request for the user plane function to regulate the inbound traffic in accordance with the configuration, where the regulation request includes an indication of the configuration.

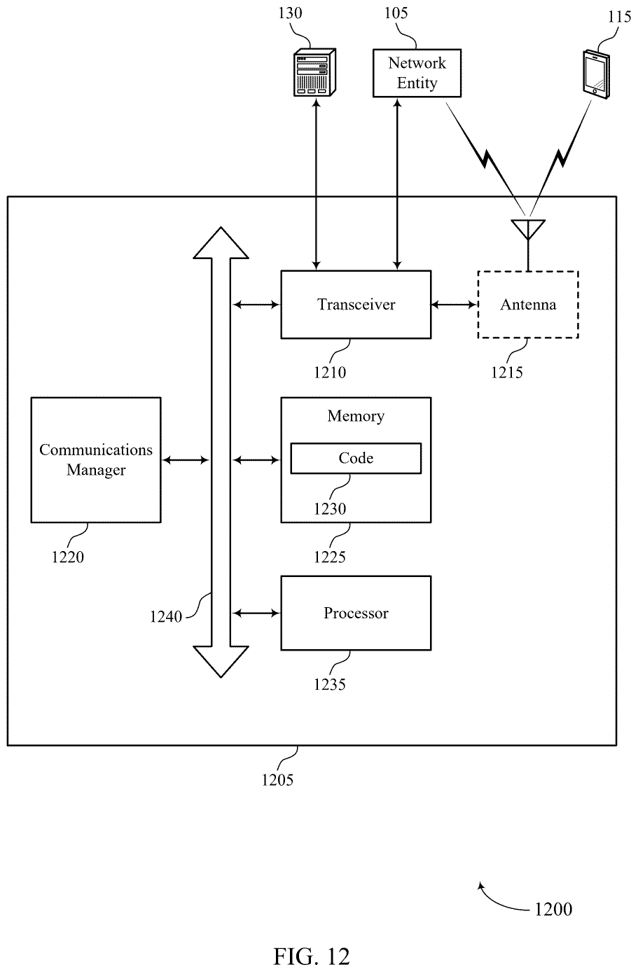

FIG. 12 shows a diagram of a system 1200 including a device 1205 that supports inbound transport for UE hosted data services in accordance with one or more aspects of the present disclosure. The device 1205 may be an example of or include components of a device 905, a device 1005, or a management entity as described herein. The device 1205 may include components for bi-directional voice and data communications including components for transmitting and receiving communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting inbound transport for UE hosted data services). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, via a wireless communications link and from a UE, a first NAS message including a request to pass inbound traffic to the UE, where the inbound traffic is associated with a first service hosted at the UE. The communications manager 1220 is capable of, configured to, or operable to support a means for transmitting, to a second management entity, a verification message to verify whether the UE is associated with a subscription to pass the inbound traffic. The communications manager 1220 is capable of, configured to, or operable to support a means for transmitting, to the UE, a second NAS message that indicates that the request to pass the inbound traffic is accepted in accordance with the UE being associated with the subscription.

Additionally, or alternatively, the communications manager 1220 may support wireless communications in accordance with examples as disclosed herein. For example, the communications manager 1220 is capable of, configured to, or operable to support a means for receiving, via a wireless communications link and from a UE, a first message including a request to communicate with a PCP server used to pass inbound traffic to the UE. The communications manager 1220 is capable of, configured to, or operable to support a means for transmitting, via the wireless communications link and in accordance with receiving the first message, a second message that indicates an IP address of the PCP server, a domain name of the PCP server, or both, where the inbound traffic is associated with a first service hosted at the UE. The communications manager 1220 is capable of, configured to, or operable to support a means for receiving, via the wireless communications link, a first NAS message that indicates a set of transport or traffic characteristics associated with the inbound traffic. The communications manager 1220 is capable of, configured to, or operable to support a means for transmitting, to the UE, a second NAS message that indicates that the request to communicate with the PCP server is accepted in accordance with the UE being associated with a subscription to pass the inbound traffic.

By including or configuring the communications manager 1220 in accordance with examples as described herein, the device 1205 may support techniques for inbound transport for UE hosted data services, which may result in improved communication reliability, reduced latency, improved user experience related to reduced processing for some devices, reduced power consumption, more efficient utilization of communication resources, increased data security, improved coordination between devices, improved utilization of processing capability, and more efficient service hosting capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of inbound transport for UE hosted data services as described herein, or the at least one processor 1235 and the at least one memory 1225 may be otherwise configured to, individually or collectively, perform or support such operations.

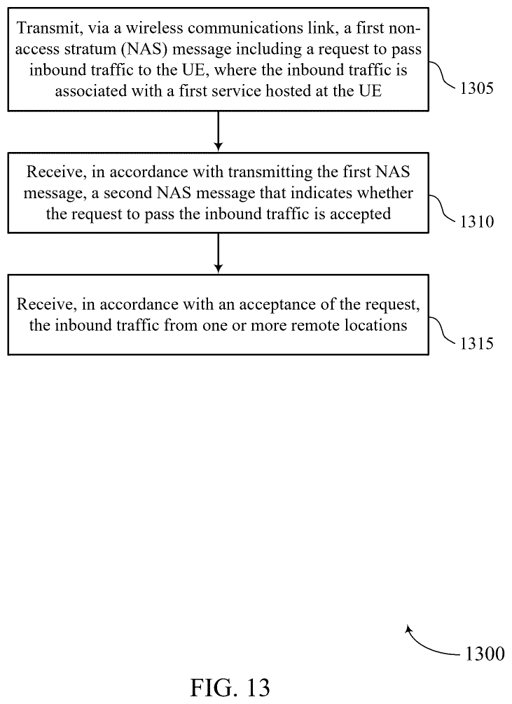

FIG. 13 shows a flowchart illustrating a method 1300 that supports inbound transport for UE hosted data services in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, via a wireless communications link, a first NAS message including a request to pass inbound traffic to the UE, where the inbound traffic is associated with a first service hosted at the UE. The operations of 1305 may be performed in accordance with examples as disclosed herein. In some examples, aspects of the operations of 1305 may be performed by a NAS request component 725 as described with reference to FIG. 7.

At 1310, the method may include receiving, in accordance with transmitting the first NAS message, a second NAS message that indicates whether the request to pass the inbound traffic is accepted. The operations of 1310 may be performed in accordance with examples as disclosed herein. In some examples, aspects of the operations of 1310 may be performed by a NAS acknowledgment component 730 as described with reference to FIG. 7.

At 1315, the method may include receiving, in accordance with an acceptance of the request, the inbound traffic from one or more remote locations. The operations of 1315 may be performed in accordance with examples as disclosed herein. In some examples, aspects of the operations of 1315 may be performed by an inbound traffic component 735 as described with reference to FIG. 7.

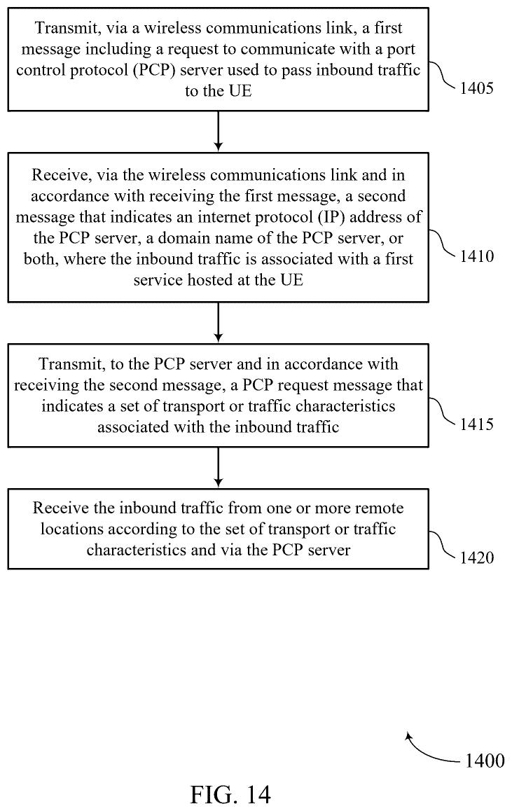

FIG. 14 shows a flowchart illustrating a method 1400 that supports inbound transport for UE hosted data services in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting, via a wireless communications link, a first message including a request to communicate with a PCP server used to pass inbound traffic to the UE. The operations of 1405 may be performed in accordance with examples as disclosed herein. In some examples, aspects of the operations of 1405 may be performed by a PDU request component 740 as described with reference to FIG. 7.

At 1410, the method may include receiving, via the wireless communications link and in accordance with receiving the first message, a second message that indicates an IP address of the PCP server, a domain name of the PCP server, or both, where the inbound traffic is associated with a first service hosted at the UE. The operations of 1410 may be performed in accordance with examples as disclosed herein. In some examples, aspects of the operations of 1410 may be performed by a PDU response component 745 as described with reference to FIG. 7.

At 1415, the method may include transmitting, to the PCP server and in accordance with receiving the second message, a PCP request message that indicates a set of transport or traffic characteristics associated with the inbound traffic. The operations of 1415 may be performed in accordance with examples as disclosed herein. In some examples, aspects of the operations of 1415 may be performed by a PCP request component 750 as described with reference to FIG. 7.

At 1420, the method may include receiving the inbound traffic from one or more remote locations according to the set of transport or traffic characteristics and via the PCP server. The operations of 1420 may be performed in accordance with examples as disclosed herein. In some examples, aspects of the operations of 1420 may be performed by an inbound traffic component 735 as described with reference to FIG. 7.

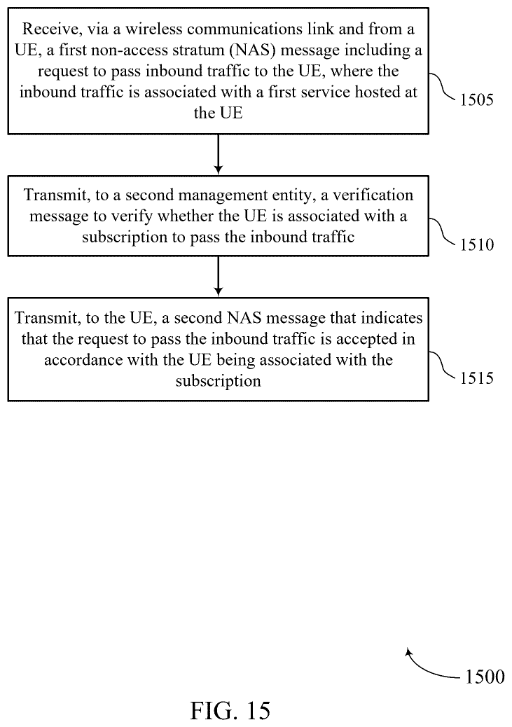

FIG. 15 shows a flowchart illustrating a method 1500 that supports inbound transport for UE hosted data services in accordance with one or more aspects of the present disclosure. The operations of the method 1500 may be implemented by a management entity or its components as described herein. For example, the operations of the method 1500 may be performed by a management entity as described with reference to FIGS. 1 through 4 and 9 through 12. In some examples, a management entity may execute a set of instructions to control the functional elements of the management entity to perform the described functions. Additionally, or alternatively, the management entity may perform aspects of the described functions using special-purpose hardware.

At 1505, the method may include receiving, via a wireless communications link and from a UE, a first NAS message including a request to pass inbound traffic to the UE, where the inbound traffic is associated with a first service hosted at the UE. The operations of 1505 may be performed in accordance with examples as disclosed herein. In some examples, aspects of the operations of 1505 may be performed by a NAS request manager 1125 as described with reference to FIG. 11.

At 1510, the method may include transmitting, to a second management entity, a verification message to verify whether the UE is associated with a subscription to pass the inbound traffic. The operations of 1510 may be performed in accordance with examples as disclosed herein. In some examples, aspects of the operations of 1510 may be performed by a verification manager 1130 as described with reference to FIG. 11.

At 1515, the method may include transmitting, to the UE, a second NAS message that indicates that the request to pass the inbound traffic is accepted in accordance with the UE being associated with the subscription. The operations of 1515 may be performed in accordance with examples as disclosed herein. In some examples, aspects of the operations of 1515 may be performed by an authorization manager 1135 as described with reference to FIG. 11.

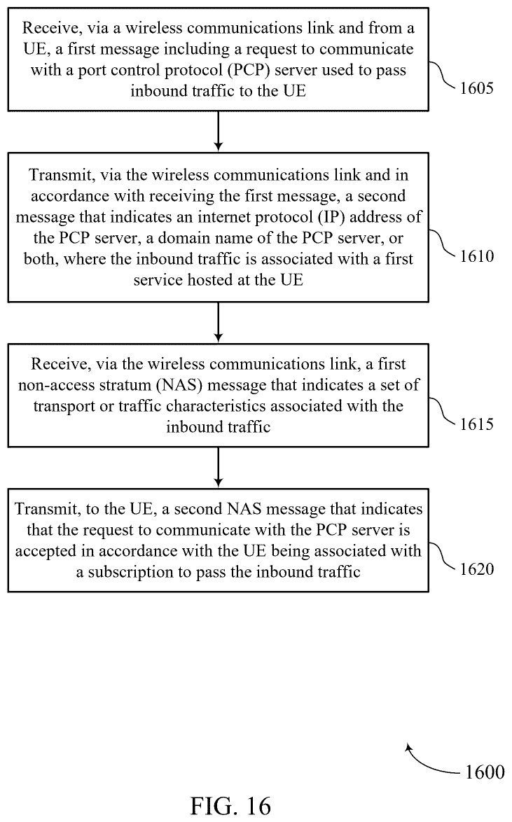

FIG. 16 shows a flowchart illustrating a method 1600 that supports inbound transport for UE hosted data services in accordance with one or more aspects of the present disclosure. The operations of the method 1600 may be implemented by a management entity or its components as described herein. For example, the operations of the method 1600 may be performed by a management entity as described with reference to FIGS. 1 through 4 and 9 through 12. In some examples, a management entity may execute a set of instructions to control the functional elements of the management entity to perform the described functions. Additionally, or alternatively, the management entity may perform aspects of the described functions using special-purpose hardware.

At 1605, the method may include receiving, via a wireless communications link and from a UE, a first message including a request to communicate with a PCP server used to pass inbound traffic to the UE. The operations of 1605 may be performed in accordance with examples as disclosed herein. In some examples, aspects of the operations of 1605 may be performed by a PDU request manager 1140 as described with reference to FIG. 11.

At 1610, the method may include transmitting, via the wireless communications link and in accordance with receiving the first message, a second message that indicates an IP address of the PCP server, a domain name of the PCP server, or both, where the inbound traffic is associated with a first service hosted at the UE. The operations of 1610 may be performed in accordance with examples as disclosed herein. In some examples, aspects of the operations of 1610 may be performed by a PDU response manager 1145 as described with reference to FIG. 11.

At 1615, the method may include receiving, via the wireless communications link, a first NAS message that indicates a set of transport or traffic characteristics associated with the inbound traffic. The operations of 1615 may be performed in accordance with examples as disclosed herein. In some examples, aspects of the operations of 1615 may be performed by a traffic characteristics manager 1150 as described with reference to FIG. 11.

At 1620, the method may include transmitting, to the UE, a second NAS message that indicates that the request to communicate with the PCP server is accepted in accordance with the UE being associated with a subscription to pass the inbound traffic. The operations of 1620 may be performed in accordance with examples as disclosed herein. In some examples, aspects of the operations of 1620 may be performed by a PCP acknowledgment manager 1155 as described with reference to FIG. 11.

The following provides an overview of aspects of the present disclosure:
Aspect 1: A method for wireless communications at a UE, comprising: transmitting, via a wireless communications link, a first NAS message comprising a request to pass inbound traffic to the UE, wherein the inbound traffic is associated with a first service hosted at the UE; receiving, in accordance with transmitting the first NAS message, a second NAS message that indicates whether the request to pass the inbound traffic is accepted; and receiving, in accordance with an acceptance of the request, the inbound traffic from one or more remote locations.
Aspect 2: The method of aspect 1, further comprising: transmitting, via the wireless communications link and as part of a procedure for establishing a PDU session, a message comprising a request for a publicly routable IP address or a publicly routable IP prefix; and receiving, in response to the message and as part of the procedure, an indication of the publicly routable IP prefix or the publicly routable IP address for the PDU session, wherein transmitting the first NAS message is in accordance with receiving the indication.
Aspect 3: The method of aspect 2, further comprising: selecting, in accordance with receiving the indication, an IP address for the first service according to the publicly routable IP prefix, wherein the first NAS message includes an indication of the selected IP address for the first service.
Aspect 4: The method of aspect 3, further comprising: initializing, in accordance with the acceptance of the request to pass the inbound traffic, one or more server functions associated with the first service for the selected IP address, wherein receiving the inbound traffic is in accordance with initializing the one or more server functions.
Aspect 5: The method of any of aspects 1 through 4, further comprising: transmitting, to the one or more remote locations, one or more response messages in response to the inbound traffic.
Aspect 6: The method of any of aspects 1 through 5, wherein each of the one or more remote locations corresponds to a respective IP address, a respective IP prefix, or any combination thereof.
Aspect 7: The method of any of aspects 1 through 6, wherein the first NAS message further comprises an indication of a set of transport or traffic characteristics associated with the inbound traffic, and receiving the inbound traffic is based at least in part on the inbound traffic being in accordance with the set of transport or traffic characteristics.
Aspect 8: The method of aspect 7, wherein the set of transport or traffic characteristics includes an IP address associated with the first service, a transport layer protocol type associated with the first service, a transport layer port identifier associated with the first service, or any combination thereof.
Aspect 9: The method of any of aspects 7 through 8, wherein the set of transport or traffic characteristics includes a range of supported IP addresses associated with the one or more remote locations associated with the inbound traffic, a range of supported transport protocol port identifiers associated with the one or more remote locations, or both.
Aspect 10: The method of any of aspects 7 through 9, wherein the set of transport or traffic characteristics includes a range of restricted IP addresses that are restricted from communicating inbound traffic.
Aspect 11: The method of any of aspects 7 through 10, wherein the set of transport or traffic characteristics includes one or more first time windows during which the inbound traffic is permitted to be communicated, one or more second time windows during which the inbound traffic is restricted from being communicated, or both.
Aspect 12: The method of any of aspects 7 through 11, wherein the set of transport or traffic characteristics includes a first threshold quantity of inbound traffic attempts permitted per time interval per remote location of the one or more remote locations, a second threshold quantity of inbound traffic attempts permitted per time interval in total, or both.
Aspect 13: A method for wireless communications at a UE, comprising: transmitting, via a wireless communications link, a first message comprising a request to communicate with a PCP server used to pass inbound traffic to the UE; receiving, via the wireless communications link and in accordance with receiving the first message, a second message that indicates an IP address of the PCP server, a domain name of the PCP server, or both, wherein the inbound traffic is associated with a first service hosted at the UE; transmitting, to the PCP server and in accordance with receiving the second message, a PCP request message that indicates a set of transport or traffic characteristics associated with the inbound traffic; and receiving the inbound traffic from one or more remote locations according to the set of transport or traffic characteristics and via the PCP server.
Aspect 14: The method of aspect 13, further comprising: establishing the wireless communications link with a management entity of a core network associated with the UE, wherein the wireless communications link comprises a RRC connection.
Aspect 15: The method of any of aspects 13 through 14, further comprising: transmitting, via the first message, a second request for a set of publicly routable IP addresses comprising the IP address of the PCP server, wherein receiving the second message is in accordance with transmitting the second request.
Aspect 16: The method of any of aspects 13 through 15, further comprising: receiving, via the second message, a publicly routable IP prefix for a PDU session, wherein the IP address of the PCP server is in accordance with the publicly routable IP prefix.
Aspect 17: The method of any of aspects 13 through 16, further comprising: receiving, in response to the PCP request message, a PCP acknowledgment message that indicates an acceptance of the PCP request message, wherein receiving the inbound traffic is in accordance with the acceptance of the PCP request message.
Aspect 18: The method of any of aspects 13 through 17, further comprising: initializing one or more server functions associated with the first service for the IP address of the PCP server, wherein receiving the inbound traffic is in accordance with initializing the one or more server functions.
Aspect 19: The method of any of aspects 13 through 18, further comprising: transmitting, to the one or more remote locations, one or more response messages in response to the inbound traffic.
Aspect 20: The method of any of aspects 13 through 19, wherein the set of transport or traffic characteristics includes an IP address associated with the first service, a transport layer protocol type associated with the first service, a transport layer port identifier associated with the first service, or any combination thereof.
Aspect 21: The method of any of aspects 13 through 20, wherein the set of transport or traffic characteristics includes a range of supported IP addresses associated with the one or more remote locations, a range of supported transport protocol port identifiers associated with the one or more remote locations, or both.
Aspect 22: The method of any of aspects 13 through 21, wherein the set of transport or traffic characteristics includes a range of restricted IP addresses that are restricted from communicating inbound traffic.
Aspect 23: A method for wireless communications at a management entity, comprising: receiving, via a wireless communications link and from a UE, a first NAS message comprising a request to pass inbound traffic to the UE, wherein the inbound traffic is associated with a first service hosted at the UE; transmitting, to a second management entity, a verification message to verify whether the UE is associated with a subscription to pass the inbound traffic; and transmitting, to the UE, a second NAS message that indicates that the request to pass the inbound traffic is accepted in accordance with the UE being associated with the subscription.
Aspect 24: The method of aspect 23, further comprising: receiving, from the second management entity, a data management message that indicates that the UE permits passing the inbound traffic, wherein transmitting the second NAS message is in accordance with the data management message.
Aspect 25: The method of any of aspects 23 through 24, further comprising: establishing a charging association for the first service in accordance with verifying that the UE is associated with the subscription to host the first service, wherein transmitting the second NAS message is responsive to establishing the charging association.
Aspect 26: The method of any of aspects 23 through 25, wherein the first NAS message further comprises an indication of a set of traffic characteristics associated with passing the inbound traffic.
Aspect 27: The method of aspect 26, further comprising: generating, in accordance with the set of traffic characteristics, a configuration associated with passing the inbound traffic, wherein transmitting the second NAS message is responsive to generating the configuration.
Aspect 28: The method of aspect 27, further comprising: transmitting, to a UPF, a regulation request for the UPF to regulate the inbound traffic in accordance with the configuration, wherein the regulation request includes an indication of the configuration.
Aspect 29: A method for wireless communications at a management entity, comprising: receiving, via a wireless communications link and from a UE, a first message comprising a request to communicate with a PCP server used to pass inbound traffic to the UE; transmitting, via the wireless communications link and in accordance with receiving the first message, a second message that indicates an IP address of the PCP server, a domain name of the PCP server, or both, wherein the inbound traffic is associated with a first service hosted at the UE; receiving, via the wireless communications link, a first NAS message that indicates a set of transport or traffic characteristics associated with the inbound traffic; and transmitting, to the UE, a second NAS message that indicates that the request to communicate with the PCP server is accepted in accordance with the UE being associated with a subscription to pass the inbound traffic.
Aspect 30: The method of aspect 29, further comprising: selecting a UPF that supports the PCP server; and receiving, from the UPF, an IP address message comprising the IP address of the PCP server, wherein transmitting the second NAS message is in accordance with receiving the IP address message.
Aspect 31: The method of any of aspects 29 through 30, further comprising: exchanging one or more messages with a second management entity to verify whether the UE is associated with the subscription to pass the inbound traffic, wherein transmitting the second NAS message is in accordance with the UE being associated with the subscription.
Aspect 32: The method of any of aspects 29 through 31, further comprising: establishing a charging association for the first service in accordance with verifying that the UE is associated with the subscription to host the first service, wherein transmitting the second NAS message is responsive to establishing the charging association.
Aspect 33: The method of any of aspects 29 through 32, further comprising: generating, in accordance with the set of transport or traffic characteristics, a configuration associated with passing the inbound traffic; and transmitting, to a UPF, a regulation request for the UPF to regulate the inbound traffic in accordance with the configuration, wherein the regulation request includes an indication of the configuration.
Aspect 34: A UE for wireless communications, comprising one or more memories storing processor-executable code, and one or more processors coupled with the one or more memories and individually or collectively operable to execute the code to cause the UE to perform a method of any of aspects 1 through 12.
Aspect 35: A UE for wireless communications, comprising at least one means for performing a method of any of aspects 1 through 12.
Aspect 36: A non-transitory computer-readable medium storing code for wireless communications, the code comprising instructions executable by one or more processors to perform a method of any of aspects 1 through 12.
Aspect 37: A UE for wireless communications, comprising one or more memories storing processor-executable code, and one or more processors coupled with the one or more memories and individually or collectively operable to execute the code to cause the UE to perform a method of any of aspects 13 through 22.
Aspect 38: A UE for wireless communications, comprising at least one means for performing a method of any of aspects 13 through 22.
Aspect 39: A non-transitory computer-readable medium storing code for wireless communications, the code comprising instructions executable by one or more processors to perform a method of any of aspects 13 through 22.
Aspect 40: A management entity for wireless communications, comprising one or more memories storing processor-executable code, and one or more processors coupled with the one or more memories and individually or collectively operable to execute the code to cause the management entity to perform a method of any of aspects 23 through 28.
Aspect 41: A management entity for wireless communications, comprising at least one means for performing a method of any of aspects 23 through 28.
Aspect 42: A non-transitory computer-readable medium storing code for wireless communications, the code comprising instructions executable by one or more processors to perform a method of any of aspects 23 through 28.
Aspect 43: A management entity for wireless communications, comprising one or more memories storing processor-executable code, and one or more processors coupled with the one or more memories and individually or collectively operable to execute the code to cause the management entity to perform a method of any of aspects 29 through 33.
Aspect 44: A management entity for wireless communications, comprising at least one means for performing a method of any of aspects 29 through 33.
Aspect 45: A non-transitory computer-readable medium storing code for wireless communications, the code comprising instructions executable by one or more processors to perform a method of any of aspects 29 through 33.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, via a wireless communications link, a first non-access stratum (NAS) message comprising a request to pass inbound traffic to the UE, wherein the inbound traffic is associated with a first service hosted at the UE;
receive, in accordance with transmitting the first NAS message, a second NAS message that indicates whether the request to pass the inbound traffic is accepted; and
receive, in accordance with an acceptance of the request, the inbound traffic from one or more remote locations.

2. The UE of claim 1, wherein the one or more processors are individually or collectively further operable to execute the code to cause the UE to:
transmit, via the wireless communications link and as part of a procedure for establishing a packet data unit (PDU) session, a message comprising a request for a publicly routable internet protocol (IP) address or a publicly routable IP prefix; and
receive, in response to the message and as part of the procedure, an indication of the publicly routable IP prefix or the publicly routable IP address for the PDU session, wherein transmitting the first NAS message is in accordance with receiving the indication.

3. The UE of claim 2, wherein the one or more processors are individually or collectively further operable to execute the code to cause the UE to:
select, in accordance with receiving the indication, an IP address for the first service according to the publicly routable IP prefix, wherein the first NAS message includes an indication of the selected IP address for the first service.

4. The UE of claim 3, wherein the one or more processors are individually or collectively further operable to execute the code to cause the UE to:
initialize, in accordance with the acceptance of the request to pass the inbound traffic, one or more server functions associated with the first service for the selected IP address, wherein receiving the inbound traffic is in accordance with initializing the one or more server functions.

5. The UE of claim 1, wherein the one or more processors are individually or collectively further operable to execute the code to cause the UE to:
transmit, to the one or more remote locations, one or more response messages in response to the inbound traffic.

6. The UE of claim 1, wherein each of the one or more remote locations corresponds to a respective internet protocol (IP) address, a respective IP prefix, or any combination thereof.

7. The UE of claim 1, wherein:
the first NAS message further comprises an indication of a set of transport or traffic characteristics associated with the inbound traffic, and
receiving the inbound traffic is based at least in part on the inbound traffic being in accordance with the set of transport or traffic characteristics.

8. The UE of claim 7, wherein the set of transport or traffic characteristics includes an IP address associated with the first service, a transport layer protocol type associated with the first service, a transport layer port identifier associated with the first service, or any combination thereof.

9. The UE of claim 7, wherein the set of transport or traffic characteristics includes a range of supported IP addresses associated with the one or more remote locations associated with the inbound traffic, a range of supported transport protocol port identifiers associated with the one or more remote locations, or both.

10. The UE of claim 7, wherein the set of transport or traffic characteristics includes a range of restricted IP addresses that are restricted from communicating the inbound traffic.

11. The UE of claim 7, wherein the set of transport or traffic characteristics includes one or more first time windows during which the inbound traffic is permitted to be communicated, one or more second time windows during which the inbound traffic is restricted from being communicated, or both.

12. The UE of claim 7, wherein the set of transport or traffic characteristics includes a first threshold quantity of inbound traffic attempts permitted per time interval per remote location of the one or more remote locations, a second threshold quantity of inbound traffic attempts permitted per time interval in total, or both.

13. A user equipment (UE), comprising:
one or more memories storing processor-executable code; and
one or more processors coupled with the one or more memories and individually or collectively operable to execute the code to cause the UE to:
transmit, via a wireless communications link, a first message comprising a request to communicate with a port control protocol (PCP) server used to pass inbound traffic to the UE;
receive, via the wireless communications link and in accordance with receiving the first message, a second message that indicates an internet protocol (IP) address of the PCP server, a domain name of the PCP server, or both, wherein the inbound traffic is associated with a first service hosted at the UE;
transmit, to the PCP server and in accordance with receiving the second message, a PCP request message that indicates a set of transport or traffic characteristics associated with the inbound traffic; and
receive the inbound traffic from one or more remote locations according to the set of transport or traffic characteristics and via the PCP server.

14. The UE of claim 13, wherein the one or more processors are individually or collectively further operable to execute the code to cause the UE to:
establish the wireless communications link with a management entity of a core network associated with the UE, wherein the wireless communications link comprises a radio resource control connection.

15. The UE of claim 13, wherein the one or more processors are individually or collectively further operable to execute the code to cause the UE to:
transmit, via the first message, a second request for a set of publicly routable IP addresses comprising the IP address of the PCP server, wherein receiving the second message is in accordance with transmitting the second request.

16. The UE of claim 13, wherein the one or more processors are individually or collectively further operable to execute the code to cause the UE to:
receive, via the second message, a publicly routable IP prefix for a packet data unit (PDU) session, wherein the IP address of the PCP server is in accordance with the publicly routable IP prefix.

17. The UE of claim 13, wherein the one or more processors are individually or collectively further operable to execute the code to cause the UE to:
receive, in response to the PCP request message, a PCP acknowledgment message that indicates an acceptance of the PCP request message, wherein receiving the inbound traffic is in accordance with the acceptance of the PCP request message.

18. The UE of claim 13, wherein the one or more processors are individually or collectively further operable to execute the code to cause the UE to:
initialize one or more server functions associated with the first service for the IP address of the PCP server, wherein receiving the inbound traffic is in accordance with initializing the one or more server functions.

19. The UE of claim 13, wherein the one or more processors are individually or collectively further operable to execute the code to cause the UE to:
transmit, to the one or more remote locations, one or more response messages in response to the inbound traffic.

20. A management entity, comprising:
one or more memories storing processor-executable code; and
one or more processors coupled with the one or more memories and individually or collectively operable to execute the code to cause the management entity to:
receive, via a wireless communications link and from a user equipment (UE), a first non-access stratum (NAS) message comprising a request to pass inbound traffic to the UE, wherein the inbound traffic is associated with a first service hosted at the UE;
transmit, to a second management entity, a verification message to verify whether the UE is associated with a subscription to pass the inbound traffic; and
transmit, to the UE, a second NAS message that indicates that the request to pass the inbound traffic is accepted in accordance with the UE being associated with the subscription.

21. The management entity of claim 20, wherein the one or more processors are individually or collectively further operable to execute the code to cause the management entity to:
receive, from the second management entity, a data management message that indicates that the UE permits passing the inbound traffic, wherein transmitting the second NAS message is in accordance with the data management message.

22. The management entity of claim 20, wherein the one or more processors are individually or collectively further operable to execute the code to cause the management entity to:
establish a charging association for the first service in accordance with verifying that the UE is associated with the subscription to host the first service, wherein transmitting the second NAS message is responsive to establishing the charging association.

23. The management entity of claim 20, wherein the first NAS message further comprises an indication of a set of traffic characteristics associated with passing the inbound traffic.

24. The management entity of claim 23, wherein the one or more processors are individually or collectively further operable to execute the code to cause the management entity to:
generate, in accordance with the set of traffic characteristics, a configuration associated with passing the inbound traffic, wherein transmitting the second NAS message is responsive to generating the configuration.

25. The management entity of claim 24, wherein the one or more processors are individually or collectively further operable to execute the code to cause the management entity to:
transmit, to a user plane function, a regulation request for the user plane function to regulate the inbound traffic in accordance with the configuration, wherein the regulation request includes an indication of the configuration.

26. A management entity, comprising:
one or more memories storing processor-executable code; and
one or more processors coupled with the one or more memories and individually or collectively operable to execute the code to cause the management entity to:
receive, via a wireless communications link and from a user equipment (UE), a first message comprising a request to communicate with a port control protocol (PCP) server used to pass inbound traffic to the UE;
transmit, via the wireless communications link and in accordance with receiving the first message, a second message that indicates an internet protocol (IP) address of the PCP server, a domain name of the PCP server, or both, wherein the inbound traffic is associated with a first service hosted at the UE;
receive, via the wireless communications link, a first non-access stratum (NAS) message that indicates a set of transport or traffic characteristics associated with the inbound traffic; and
transmit, to the UE, a second NAS message that indicates that the request to communicate with the PCP server is accepted in accordance with the UE being associated with a subscription to pass the inbound traffic.

27. The management entity of claim 26, wherein the one or more processors are individually or collectively further operable to execute the code to cause the management entity to:
select a user plane function that supports the PCP server; and
receive, from the user plane function, an IP address message comprising the IP address of the PCP server, wherein transmitting the second NAS message is in accordance with receiving the IP address message.

28. The management entity of claim 26, wherein the one or more processors are individually or collectively further operable to execute the code to cause the management entity to:
exchange one or more messages with a second management entity to verify whether the UE is associated with the subscription to pass the inbound traffic, wherein transmitting the second NAS message is in accordance with the UE being associated with the subscription.

29. The management entity of claim 26, wherein the one or more processors are individually or collectively further operable to execute the code to cause the management entity to:
establish a charging association for the first service in accordance with verifying that the UE is associated with the subscription to host the first service, wherein transmitting the second NAS message is responsive to establishing the charging association.

30. The management entity of claim 26, wherein the one or more processors are individually or collectively further operable to execute the code to cause the management entity to:
generate, in accordance with the set of transport or traffic characteristics, a configuration associated with passing the inbound traffic; and
transmit, to a user plane function, a regulation request for the user plane function to regulate the inbound traffic in accordance with the configuration, wherein the regulation request includes an indication of the configuration.
